(19) United States
(12) Patent Application Publication
(10) Pub. No.: US 2026/0138993 A1
(43) Pub. Date: May 21, 2026

(54) ION-CONDUCTIVE COVALENT ORGANIC FRAMEWORK ELECTROLYTES FOR METAL-ION BATTERIES

(71) Applicant: Wisconsin Alumni Research Foundation, Madison, WI (US)

(72) Inventors: Dawei Feng, Madison, WI (US); Haochen Li, Madison, WI (US); Wonmi Lee, Madison, WI (US)

(21) Appl. No.: 18/953,711

(22) Filed: Nov. 20, 2024

(51) Int. Cl. C07F 1/06; H01M 10/054; H01M 10/056

(52) U.S. Cl. CPC C07F 1/06; H01M 10/054; H01M 10/056; H01M 2300/0065

(57) ABSTRACT

Covalent organic frameworks (COFs), methods of making the COFs, and metal-ion batteries incorporating the COFs as solid electrolytes are provided. The COFs comprise a crosslinked core that includes triazine groups crosslinked to phenylene groups. Anionic substituents covalently bonded to the benzene rings of the phenylene groups in the crosslinked core provide immobilized hopping sites that lower the energy barrier for the migration of metal cations through the COF. The low migration energy barriers and directional channels within the COFs impart the COFs with a high ionic conductivities, even the absence of additional salts and solvents. The metal cations can be installed in the COFs during a one-step synthesis from available reactants.

### REFERENCE TO GOVERNMENT RIGHTS

This invention was made with government support under 2132022 awarded by the National Science Foundation. The government has certain rights in the invention.

### BACKGROUND

Solid electrolytes (SEs) have become a pivotal component in the advancement of solid-state batteries, offering a path to high-performance and safer energy storage solutions. These advancements are crucial for addressing the limitations associated with liquid electrolyte-based batteries, including the risk of leakage, flammability, and restricted voltage windows. SEs boast significant benefits, such as enhanced thermal stability, non-flammability, and simplified battery design. Most research on SEs has been concentrated on lithium-ion (Li-ion) solid-state batteries, attributed to their high ionic conductivities, which is a result of lithium's minimal ionic size among metals. Nonetheless, given the scarcity and consequent expense of lithium resources, there is a need to shift towards more cost-effective and abundantly available alternatives, such as sodium-ion (Na-ion) or potassium-ion (K-ion), for energy storage applications. Na-ion or K-ion batteries present a host of advantages over their Li-ion counterparts, not just in terms of their abundance and lower cost, but also through environmental and geopolitical benefits. These include the potential for easier recycling, enhanced sustainability, a wide operating temperature range, and versatility across a range of applications. From large-scale energy storage systems to portable electronics and electric vehicles, Na-ion or K-ion batteries are particularly appealing in markets where cost and sustainability are critical considerations. However, the ionic conductivities of non-lithium ions, such as Na-ion or K-ion, are hindered by the high energetic barriers associated with the migration of bulkier ions within both inorganic and polymer solid electrolytes (SEs). In inorganic SEs, atoms are typically arranged in a closely packed mode, leaving limited intrinsic void space, which obstructs the diffusion of bulkier ions. Meanwhile, in polymer SEs, ions are often wrapped by polymer chains, making it difficult for them to hop between coordination sites as the migrating ions increase in size.

To improve the diffusivity of non-lithium ions, covalent organic frameworks (COFs) have been leveraged as SEs due to their exceptional thermal and electrochemical stability, along with notable ionic conductivity. COFs are a class of porous polymers that exhibit two- or three-dimensional periodic structures, characterized by well-defined pores formed through covalent bonds between monomers rich in lightweight atoms like carbon (C), oxygen (O), nitrogen (N), and hydrogen (H). These structures can be synthesized with precise control over kinetic and thermodynamic processes, allowing for the modulation of bond formation and reversibility, resulting in highly ordered networks with specific pore sizes, shapes, and topologies.

The unique features of COFs, including their long-range ordered channels, high stability, low density, and the capability for functionalization, position them as promising candidates for SEs. Particularly, COFs have shown potential for achieving high ionic conductivity. Unlike inorganic and polymer SEs, which often present a high energy barrier to the migration of bulky ions due to the segmental motion of polymers or the rigid crystalline spaces of inorganic solids, COFs can significantly lower the energy barrier for ion diffusion. This is attributed to their intrinsic open channels, offering ample void space for the rapid diffusion of various ions, regardless of size. This mechanism of ion conduction through COFs could potentially lead to superior ionic conductivities for bulky ions.

Although a significant amount of research over the past decade has focused on COFs as lithium-ion conductors for Li-ion solid-state batteries, investigations into COFs for non-lithium ions, such as Na-ion or K-ion-which are more abundant and cost-effective—have been relatively limited.

### SUMMARY

COFs, methods of making the COFs, and metal-ion batteries incorporating the COFs as solid electrolytes are provided.

One embodiment of a covalent organic framework includes: a crosslinked core comprising triazine groups covalently crosslinked to phenyl groups; anionic substituents grafted to phenyl rings of the phenyl groups; and metal cations associated with the anionic substituents via electrostatic interactions, wherein crosslinked core does not include imine crosslinks.

One embodiment of an electrochemical cell includes: a cathode; an anode in electrical communication with the cathode; a metal ion-permeable solid electrolyte disposed between the cathode and the anode, the solid electrolyte comprising covalent organic framework comprising: a crosslinked core comprising triazine groups covalently crosslinked to phenyl groups; anionic substituents grafted to phenyl rings of the phenyl groups; and metal cations associated with the anionic substituents via electrostatic interactions.

One embodiment of a method of making a covalent organic framework entails reacting: (a) 2,4,6-triphenoxy-1,3,5-triazine or cyanuric chloride with; (b) a phenylene diamine bearing an anionic ring substituent or a phenylene diol bearing an anionic ring substituent in the presence of a metal salt base to form the covalent organic framework comprising: a crosslinked core comprising triazine groups covalently crosslinked to phenyl groups; anionic substituents grafted to phenyl rings of the phenyl groups; and metal cations associated with the anionic substituents via electrostatic interactions

Other principal features and advantages of the invention will become apparent to those skilled in the art upon review of the following drawings, the detailed description, and the appended claims.

### BRIEF DESCRIPTION OF THE DRAWINGS

Illustrative embodiments of the invention will hereafter be described with reference to the accompanying drawings.

FIG. 1A. Schematic illustration of a COF with immobilized anionic hopping sites and electrostatically bound mobile metal cations. FIG. 1B. Schematic illustration of an electrochemical cell incorporating a COF as a solid electrolyte.

FIGS. 2A-2F. Structures of the COFs: i-COF-1 (FIG. 2A); i-COF-2 (FIG. 2B); i-COF-3 (FIG. 2C); i-COF-1-COO (FIG. 2D); i-COF-2-COO (FIG. 2E); and i-COF-3-COO (FIG. 2F).

FIGS. 3A-3B. Schematic diagrams of anion (e.g., K⁺) hopping within a pore in the absence of water (FIG. 3A) and in the presence of water (FIG. 3B).

FIGS. 4A-4B. Schematic diagrams of anion (e.g., K⁺) hopping between pores in the absence of water (FIG. 4A) and in the presence of water (FIG. 4B).

FIGS. 5A-5B. Schematic diagrams of anion (e.g., K⁺) hopping along a channel in the absence of water (FIG. 5A) and in the presence of water (FIG. 5B).

FIGS. 6A-6B. FIG. 6A shows a synthetic scheme of new design of i-COF-1 with different synthetic routes, and FIG. 6B shows an ion conducting mechanism of i-COF-1 (Na) and i-COF-1 (K).

FIGS. 7A-7F. Structural characterizations of i-COF-1 (Na) and i-COF-1 (K). FIGS. 7A and 7B show ATR-FTIR of (FIG. 7A) i-COF-1 (Na) and (FIG. 7B) i-COF-1 (K). FIGS. 7C and 7D show nitrogen adsorption and desorption isotherm recorded at 77 K of (FIG. 7C) i-COF-1 (Na) and (FIG. 7D) i-COF-1 (K). FIGS. 7E and 7F show pore size distribution profiles of (FIG. 7E) i-COF-1 (Na) and (FIG. 7F) i-COF-1 (K).

FIGS. 8A-8D. Ionic conducting properties of i-COF-1 (Na) and i-COF-1 (K). FIG. 8A shows ionic conductivity at room temperature. FIGS. 8B and 8C show EIS plots at different temperatures of (FIG. 8B) i-COF-1 (Na) and (FIG. 8C) i-COF-1 (K). FIG. 8D shows activation energy of i-COF-1 (K) and i-COF-1 (Na).

FIGS. 9A-9D. Synthetic schemes for (FIGS. 9A-9B) i-COF-2 (Na or K) and (FIGS. 9C-9D) i-COF-3 (Na or K) with different monomers.

FIGS. 10A-10D. ATR-FTIR of i-COF-2 (Na or K) and i-COF-3 (Na or K). FIGS. 10A and 10B show ATR-FTIR of (FIG. 10A) i-COF-2 (Na) and (FIG. 10B) i-COF-2 (K). FIGS. 10C and 10D show ATR-FTIR of (FIG. 10C) i-COF-3 (Na) and (FIG. 10D) i-COF-3 (K).

FIGS. 11A-11D. Ionic conducting properties of i-COF-2 (Na) and i-COF-2 (K). FIG. 11A shows ionic conductivity at room temperature. FIGS. 11B and 11C show EIS plots at different temperatures of (FIG. 11B) i-COF-2 (Na) and (FIG. 11C) i-COF-2 (K). FIG. 11D shows activation energy.

FIGS. 12A-12D. Ionic conducting properties of i-COF-3 (Na) and i-COF-3 (K). FIG. 12A shows ionic conductivity at room temperature. FIGS. 12B and 12C shows EIS plots at different temperatures of (FIG. 12B) i-COF-3 (Na) and (FIG. 12C) i-COF-3 (K). FIG. 12D shows activation energy.

FIGS. 13A-13D. Nitrogen adsorption and desorption isotherm recorded at 77 K of (FIG. 13A) i-COF-2 (K) and (FIG. 13B) i-COF-3 (K) and pore size distribution profile of (FIG. 13C) i-COF-2 (K) and (FIG. 13D) i-COF-3 (K).

### DETAILED DESCRIPTION

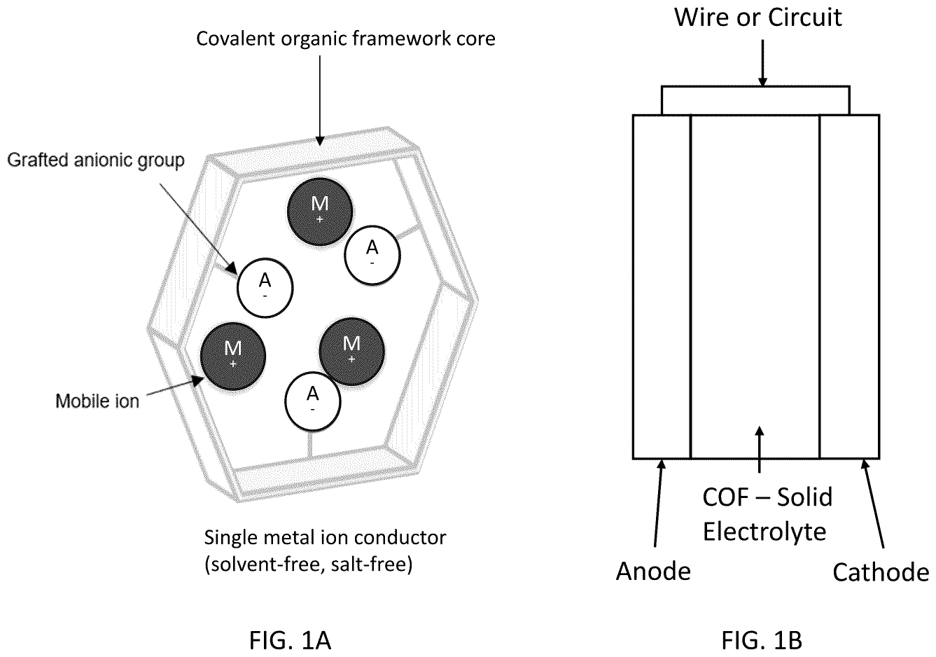

COFs, methods of making the COFs, and metal-ion batteries incorporating the COFs as solid electrolytes are provided. The COFs are porous polymers having a highly ordered network structure provided by a periodic lattice that defines ordered nano-scale pores. The COFs comprise a crosslinked core that includes triazine groups crosslinked to phenylene groups. Anionic substituents covalently bonded to the benzene rings of the phenylene groups in the crosslinked core provide immobilized hopping sites that lower the energy barrier for the migration of metal cations through the COF. The structure of the COFs is illustrated schematically in FIG. 1A, where M⁺ represents a metal cation and A⁻ represents an anionic substituent. The low migration energy barriers and directional channels within the COFs impart the COFs with a high ionic conductivities, even the absence of additional salts and solvents, making them excellent solid electrolyte materials for metal-ion batteries. The metal cations can be installed in the COFs during a one-step synthesis from available reactants.

The crosslinked core of the COFs comprises or consists only of crosslinked phenylene and triazine groups. In some embodiments, the triazine rings of the triazine groups and the benzene rings of the phenylene groups are the only aromatic rings in the crosslinked core and/or the crosslinks in the crosslinked core do not comprise or consist only of imine bonds (—HC═N—). In some embodiments of the COFs, the phenylene groups and triazine groups have an alternating (i.e., ABAB) arrangement in the core. However, an alternating ABAB arrangement of the phenylene and triazine groups in the core is not required. It is possible for additional monomers to be polymerized into the crosslinked core, but it may be advantageous to omit additional monomers, because their inclusion will reduce the charge density of the COFs. The pore size and surface area of a COF are determined, in part, by the positions of the crosslinks on the phenylene groups in the core. For example, two crosslinks on a benzene ring of a phenylene group may be present at para-positions or meta-positions on the ring. Generally, crosslinks at para positions will provide a larger pore diameter and a larger surface area.

The crosslinks connecting the aromatic rings in the core of the COF may include or consist of an amine bond, such as a secondary amine bond (—NH—) or an ether bond (—O—). However, other types of crosslinks may be used as alternatives to, or in addition to, amine and/or ether crosslinks.

The anionic substituents grafted to the benzene ring of the phenylene groups enhance the mobility of cations that interact with the anionic substituents via attractive electrostatic interactions. In some embodiments of the COFs, the anionic substituents are polyatomic anionic substituents, such as sulfonate groups (—SO₃⁻), carboxylate groups (—C(O)O⁻), phosphate groups (—OP(O)O₂²⁻) or a combination thereof. Ionic conductivity in the COF can be increased by increasing the density of the anionic hopping sites within the channels of the COF. For this reason, an alternating arrangement of triazine groups and phenylene groups in the crosslinked core may be desired because it provide a high density of phenylene groups, which bear the anionic hopping sites. In some embodiments, all the benzene rings of all phenylene groups in the crosslinked core include one or more anionic substituents. However, this is not required, and it can be sufficient for only a fraction of the benzene rings in the core to have anionic substituents. By way of illustration, COFs in which at least 50%, at least 60%, at least 70%, at least 80%, or at least 90% of the benzene rings in the crosslinked core bear one or more anionic substituents can be synthesized. Using short crosslinks, such as crosslinks that consist only of a single amine bond or only of a single ether bond also promotes a high density of anionic hopping sites in the COFs.

The COFs have pore sizes, surface areas, and anionic substituent densities that promote high ionic conductivities. Larger pore sizes facilitate cation migration, but smaller pore sizes may provide a higher density of anionic substitutes. Therefore, the optimal pore size and hopping site density may vary depending upon the structure of a given COF and the cations being transported. By way of illustration only, COFs with grafted anionic hopping sites and electrostatically bound cations having an average pore volume in the range from 0.01 to 0.3 cm³/g and/or surface areas in the range from 5 m²/g to 100 m²/g can be synthesized and used as ionic conductors, where pore volume and surface area are measured by N₂ adsorption at 77K. The anionic substituent density in the COFs can be at least 15% based on atomic density (corresponding to about 25% mass density). This includes COFs having an anionic substituent density in the range of, for example, 15% to 25% based on atomic percent, corresponding to a mass density in the range from about 25% to about 35%. However, COFs with pore sizes, surface areas, and/or anionic substituent densities outside of these ranges can be made and used.

COFs of the types described herein are characterized by high metal ion conductivities, including ionic conductivities higher than 1×10⁻⁴ S/cm. For example, ionic conductivities in the range from 1×10⁻⁴ S/cm to 4×10⁻⁴ S/cm or even higher can be achieved. These high ionic conductivities can be achieved even at room temperature (23° C.) and even in the absence of ion-containing liquids, such as salt solutions or ionic liquids, in the channels of the COFs. However, optionally, ion-containing liquids may be included within the COFs.

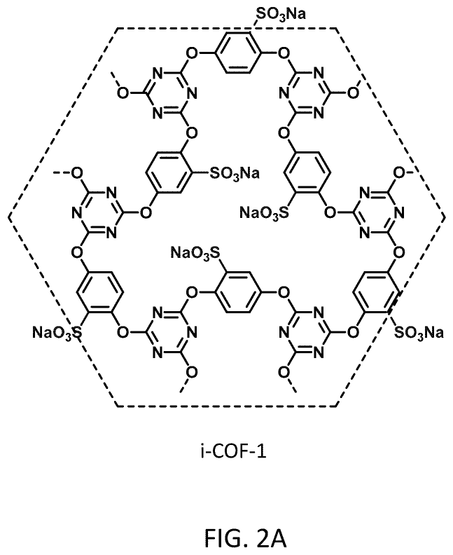

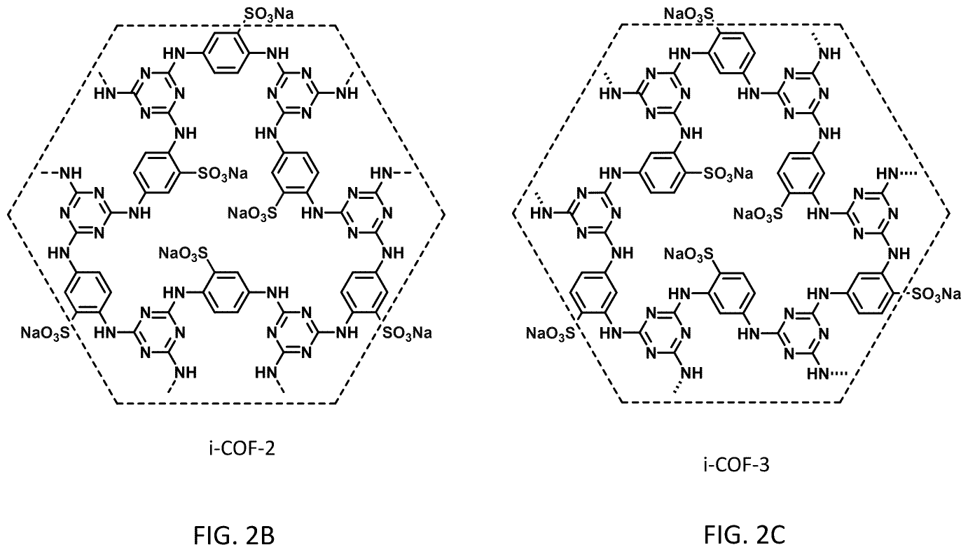

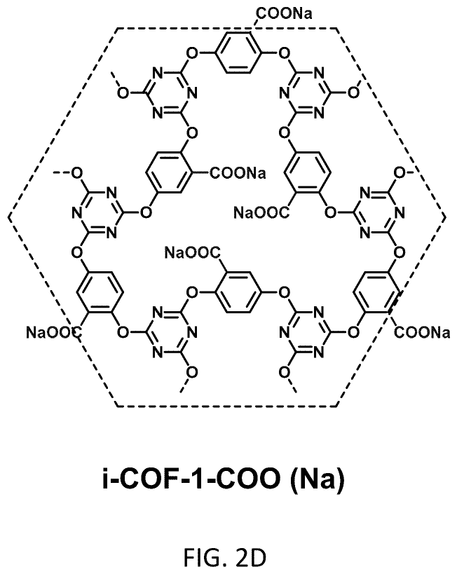

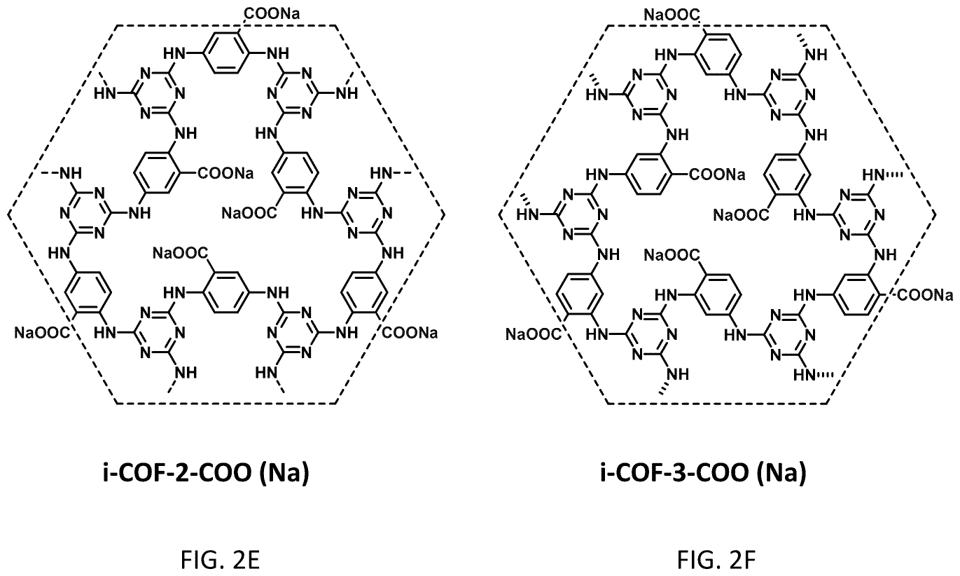

Illustrative examples of COFs having a high ionic conductivity are shown in FIGS. 2A-2F. (In these structures, dashed lines are used to indicate that only a portion of the larger polymeric network of the COF is shown.) FIG. 2A shows a COF designated “i-COF-1” having a core comprising alternating phenylene and triazine groups crosslinked by ether bonds and anionic sulfonate groups grafted to the benzene rings of the phenylene groups. FIG. 2B shows a COF designated “i-COF-2” having a core comprising alternating phenylene and triazine groups crosslinked by secondary amine bonds and anionic sulfonate groups grafted to the benzene rings of the phenylene groups. In i-COF-2, the crosslinks are at para positions on the benzene rings. FIG. 2C shows a COF designated “i-COF-3” having a core comprising alternating phenylene and triazine groups crosslinked by secondary amine bonds and anionic sulfonate groups grafted to the benzene rings of the phenylene groups. In i-COF-3, the crosslinks are at meta positions on the benzene rings.

While the anionic hopping sites in the COFs of FIGS. 2A-2C are sulfonate groups, other anionic groups, including carboxylate groups, can be used in place of some or all the sulfonate groups shown in these figures. This is illustrated in FIGS. 2D-2F, which depict: a COF designated “i-COF-1-COO” having a core comprising alternating phenylene and triazine groups crosslinked by ether bonds and anionic carboxylate groups grafted to the benzene rings of the phenylene groups (FIG. 2D); a COF designated “i-COF-2-COO” having a core comprising alternating phenylene and triazine groups crosslinked by secondary amine bonds and anionic carboxylate groups grafted to the benzene rings of the phenylene groups. In i-COF-2-COO, the crosslinks are at para positions on the benzene rings (FIG. 2E); and a COF designated “i-COF-3-COO” having a core comprising alternating phenylene and triazine groups crosslinked by secondary amine bonds and anionic carboxylate groups grafted to the benzene rings of the phenylene groups (FIG. 2F). In i-COF-3-COO, the crosslinks are at meta positions on the benzene rings.

A variety of metal cations can be installed in the COF channel during the synthesis of the COFs, as described in more detail below. FIGS. 2A-2F illustrate COFs having electrostatically bound sodium ions. However, other metal cations can be used. These include other alkali metal cations, such as potassium cations and lithium cations. However other metal cations, including other higher valent metal cations and main groups metal cations and transition metal cations, can be used. For example, other metals ions used in metal-ion batteries, such as zinc (Zn²⁺), magnesium (Mg²⁺), aluminum (Al³⁺), and manganese (Mn²⁺) cations, can be installed in the COFs.

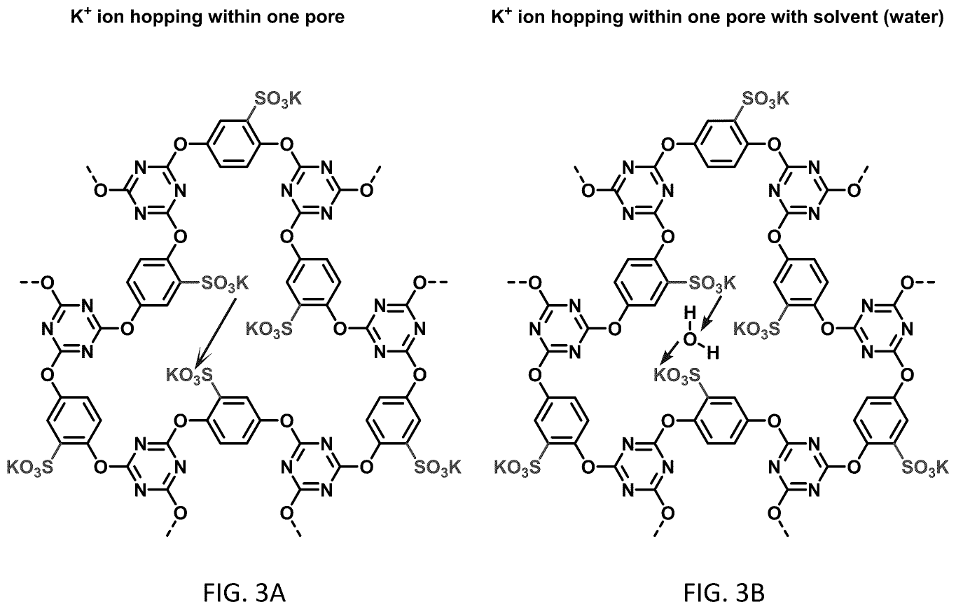

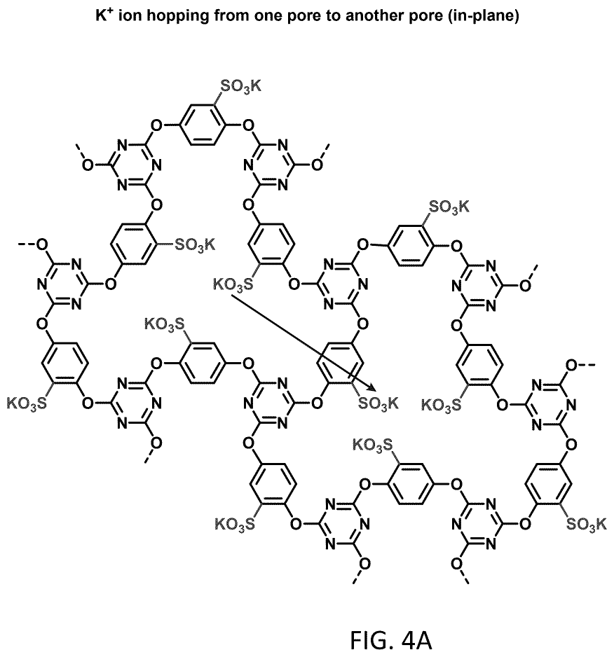

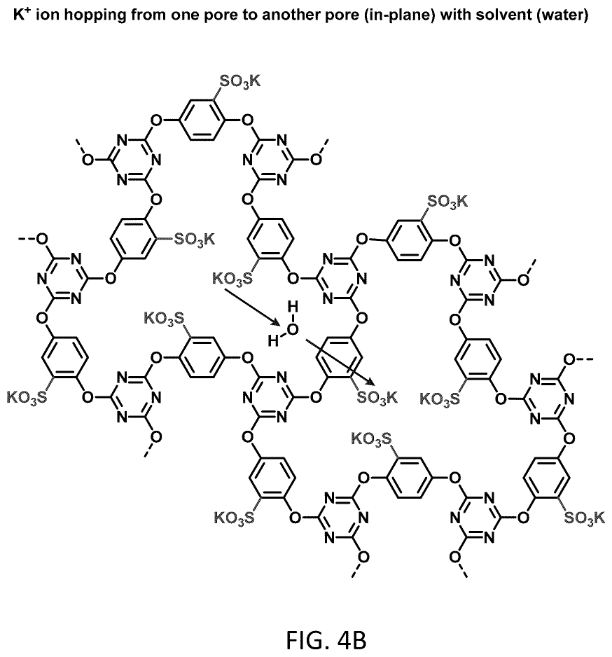

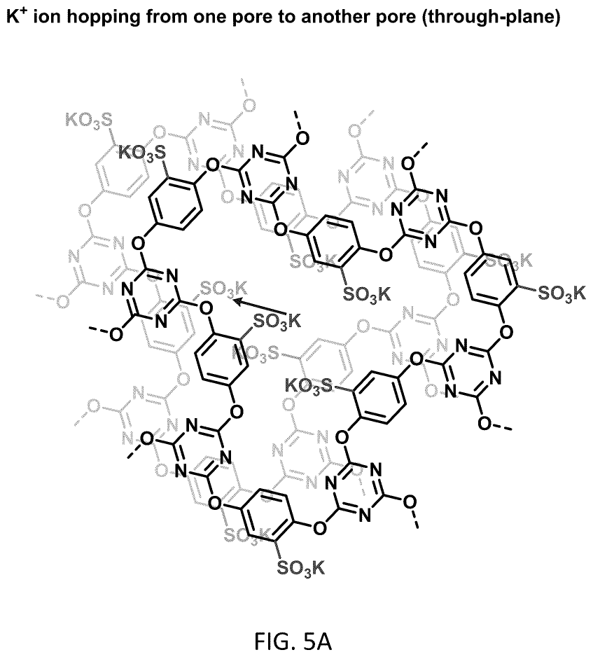

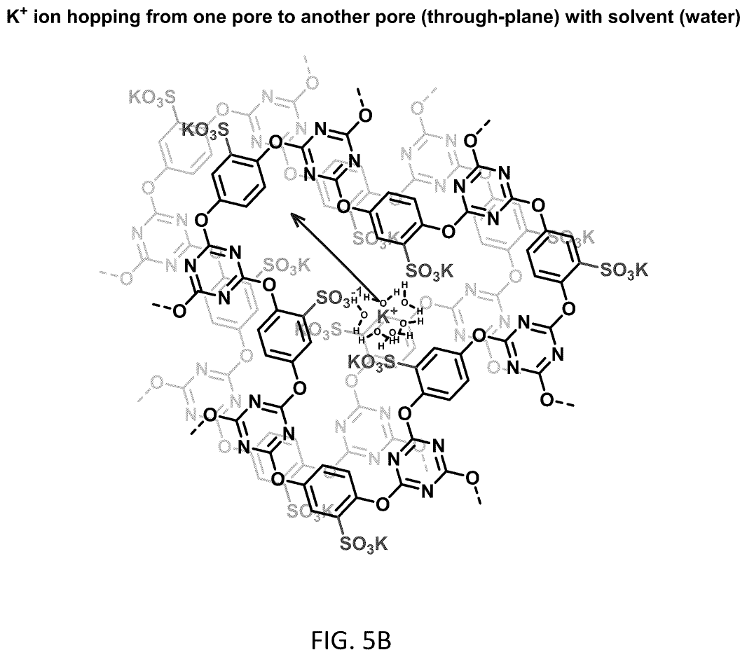

The hopping of the metal cations between the anionic substituents immobilized within the pores and channels of the COFs can take place between the anionic substituents within the same two-dimensional (2D) pore, as illustrated in FIG. 3A, between anionic substituents in neighboring pores in a 2D plane within a COF, as illustrated in FIG. 4A, and/or between hopping sites along a three-dimension (3D) channel defined within the COF (“through-plane” hopping), as illustrated in FIG. 5A.

In some embodiments of the COFs, high ionic conductivity is achieved without the need to include additional salt ions in the COF. In such embodiments, the COFs provide single-ion conductors in which the metal cations installed on the anionic hopping sites are the only ions that migrate through the COF. These single-ion conductors are distinguishable from COFs in which a solution, ionic liquid, or gel containing additional free ions (e.g., cations or cations and anions) is added to the COF to enhance ionic conductivity. However, a solvent capable of enhancing ionic conductivity, such as water, can be added to the COFs. The solvent may assist cation migration by providing additional hopping sites, thereby decreasing the hopping distance between hopping sites, as illustrated in FIG. 3B and FIG. 4B. The solvent may also assist cation migration by solvating the metal cations bound to the grafted hopping sites, thereby facilitating migration of the solvated metal cations through the COF channels, as illustrated in FIG. 5B.

The COFs with grafted anionic substituents and electrostatically bound metal ions can be synthesized using a straightforward one-step process by reacting 2,4,6-triphenoxy-1,3,5-triazine with a phenylene diamine bearing one or more anionic ring substituents or a phenylene diol bearing one or more anionic ring substituents in the presence of a metal salt base to form the COF. This reaction can be carried out as a hydrothermal synthesis using a polar organic solvent, such as N,N-dimethylformamide (DMF), with illustrative reaction temperatures in the range from 120° C. to 150° C. and illustrative reaction times in the range from 2 hours to 24 hours. Alternatively, the COFs with grafted anionic substituents and electrostatically bound metal ions can be synthesized using a straightforward one-step process by reacting cyanuric chloride with a phenylene diamine bearing one or more anionic ring substituents or a phenylene diol bearing one or more anionic ring substituents in the presence of a metal salt base to form the COF.

In the reactions, the metal salt provides the metal cations to be installed in the COF as it forms. Illustrative examples of phenylene diamines that can be used to form COFs with secondary amine crosslinks include 2,5-diaminobenzene having one or more anionic ring substituents, such as 2,5-diaminobenzene sulfonic acid or 2,5-diaminoebenzoic acid. Illustrative examples of phenylene diols that can be used to form COFs with ether crosslinks include hydroquinones having one or more anionic ring substituents, such as hydroquinone monosulfonic acid or 2,5-dihydroxybenzoic acid.

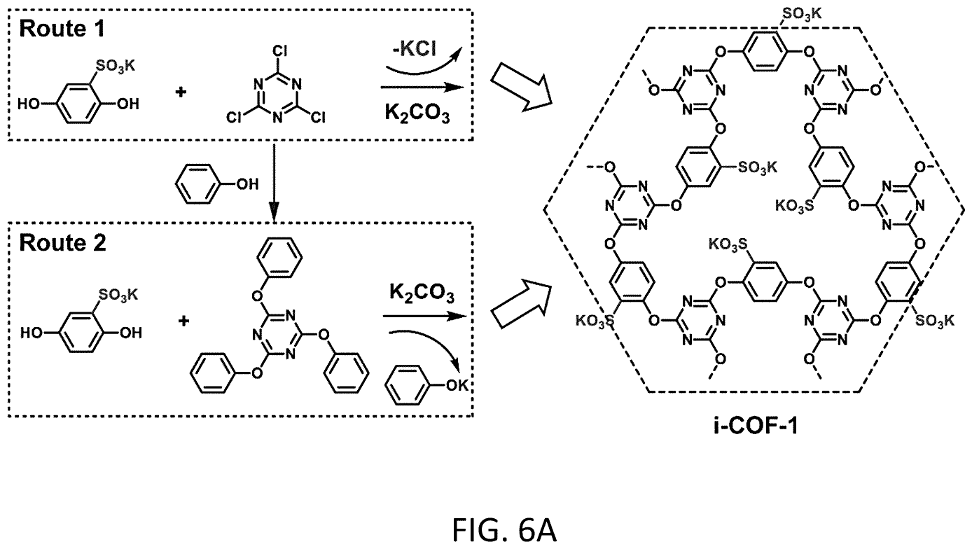

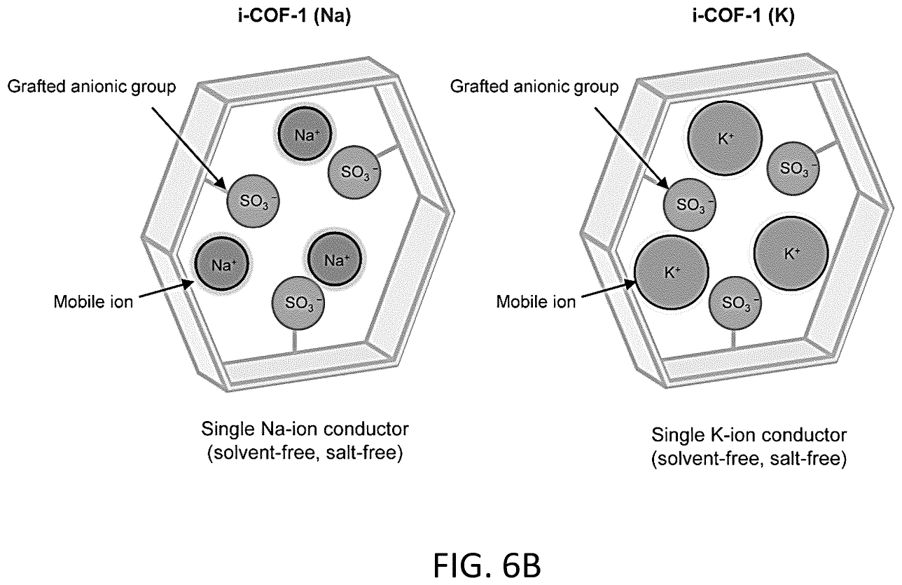

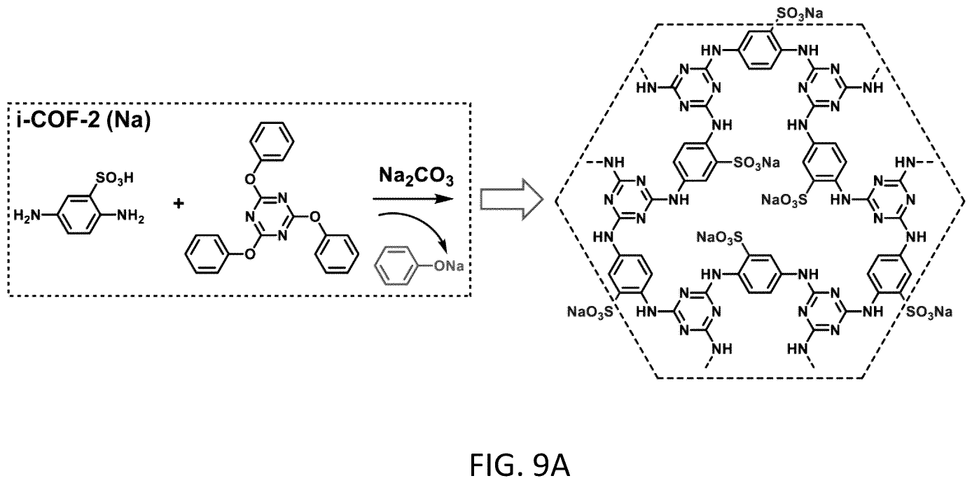

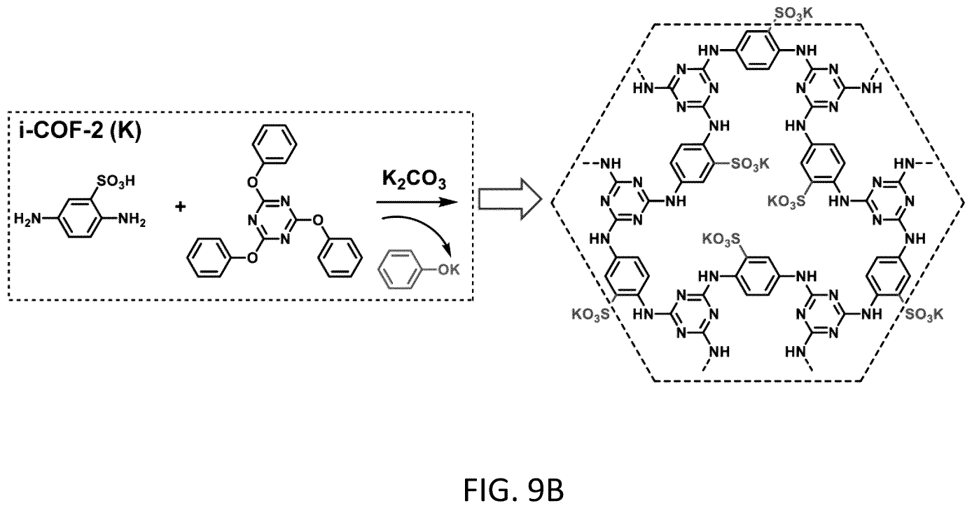

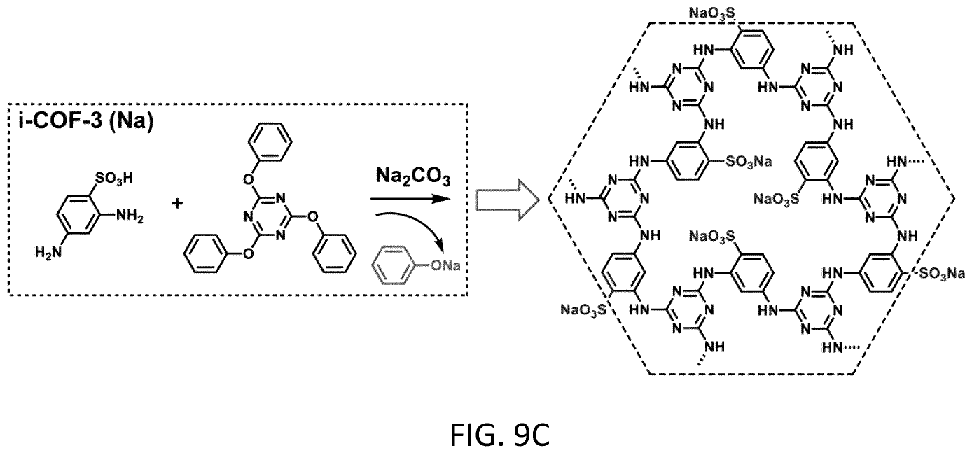

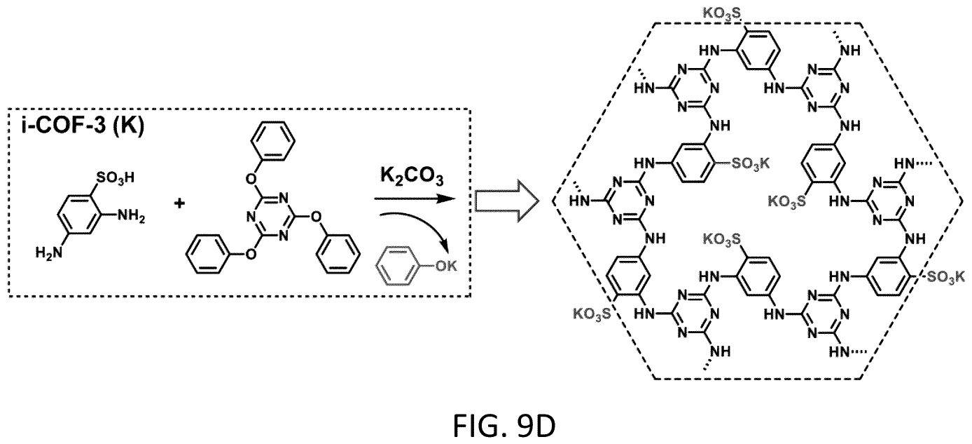

Reaction schemes for the synthesis of i-COF-1 are shown in FIG. 6A and reaction schemes for the synthesis of i-COF-2 (Na), i-COF-2 (K), i-COF-3 (Na), and i-COF-3 (K) are shown in FIG. 9A-9D, respectively. Additional details regarding the syntheses are provided in the Examples. The synthesis is desirably conducted in a solvent, typically an organic solvent, in which metal phenolate byproduct is soluble, such that only the COF precipitates out of the reaction solution. Metal carbonates are examples of metal salts that can be used. Other examples include metal hydroxides and metal alkoxides.

COFs that are formed as a powder may be compressed into a film of suitable size and dimensions for use as a solid electrolyte or may be coated onto a porous support. In some embodiments the porous support may be one of the electrodes that provide the anode or cathode for an electrochemical cell.

The COFs can be used as electrolytes in solid state electrochemical cells, including solid state metal-ion batteries. A basic embodiment of an electrochemical cell is shown schematically in FIG. 1B. The electrochemical cell includes: an anode, a cathode in electrical communication with the anode; and a metal ion-conductive COF of a type described herein disposed between the anode and the cathode that enables the migration of metal ions between the anode and the cathode. The anode and cathode are in electrical communication through a wire or electrical circuit that enables electron flow between the two electrodes upon the application of a bias voltage across the electrodes. The wire or circuit may be connected directly to the electrodes or to electrically conductive contacts or current collectors that are in contact with the electrodes. Optionally, an ion-conducting membrane can be included between the solid electrolyte and one or both electrodes to ensure electrode separation.

The electrodes that serve as the anode and cathode in a metal-ion battery include active electrode materials that contain or consist only of the metal that is conducted by the COF electrolyte, and/or materials that reversibly form intercalation compounds or alloys with the metal that is conducted by the COF electrolyte. Thus, suitable electrode materials include elemental metals (e.g., elemental sodium, potassium, lithium, magnesium, or zinc) and intercalation compounds and alloys thereof.

### EXAMPLES

### Example 1

This Example illustrates the synthesis and ionic conductivity of COFs specifically designed for sodium and potassium ion conduction—sodium sulfonated and potassium sulfonated cyanurate-linked COF, designated as i-COF-1 (Na) and i-COF-1 (K), respectively (FIGS. 6A and 6B). These two-dimensional (2D) structures can be synthesized through a process involving flexible C—O—C linkages via two routes (FIG. 6A). Route 1 employed monomers cyanuric chloride and hydroquinone monosulfonic acid potassium salt (HQ-SO₃K) to form covalent bonds, with potassium carbonate (K₂CO₃) acting as a base. The reaction proceeded under reflux in an organic solvent for one day. Post-reaction, the mixtures were vacuum-filtered, and the resultant solid COF powders were dried overnight at 60° C. in a vacuum oven. However, potassium chloride (KCl) was the byproduct which co-precipitated with i-COF-1 (K). To eliminate the interference of KCl, an alternative synthetic route was developed using TAZ-3P as a reactant to replace cyanuric chloride (Route 2), which led to the formation of potassium phenolate, a byproduct soluble in the organic solvent used during synthesis. Therefore, only i-COF-1 (K) crashed out as pure product. Powder X-ray diffraction (PXRD) analysis confirmed the presence of KCl in i-COF-1 (K) produced by Route 1, while i-COF-1 (K) synthesized by Route 2 exhibited its characteristic peaks. Similarly, i-COF-1 (Na) can be synthesized by using hydroquinone monosulfonic acid sodium salt (HQ-SO₃Na) and sodium methoxide (NaOCH₃) instead of HQ-SO₃K and K₂CO₃, respectively, via Route 2. This synthesis method is both straightforward and cost-efficient, relying on readily available starting materials.

The integration of —SO₃⁻ groups and directional channels within the COF structure enhanced the diffusivity of Na-ion or K-ion through a hopping mechanism, ensuring efficient pathways for rapid ion transport (FIG. 6B). Furthermore, the presence of anchored sulfonate groups acted as carriers for Na- or K-ions, resulting in a salt-free, solvent-free, and uniquely efficient single Na-ion or K-ion conducting SE.

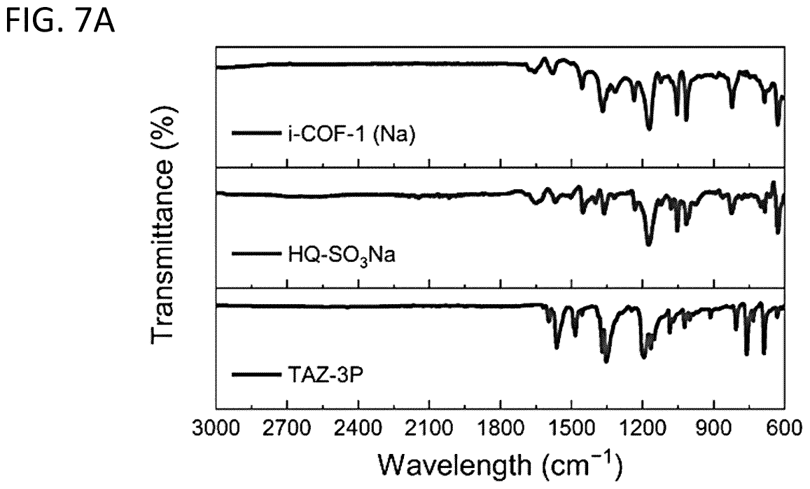

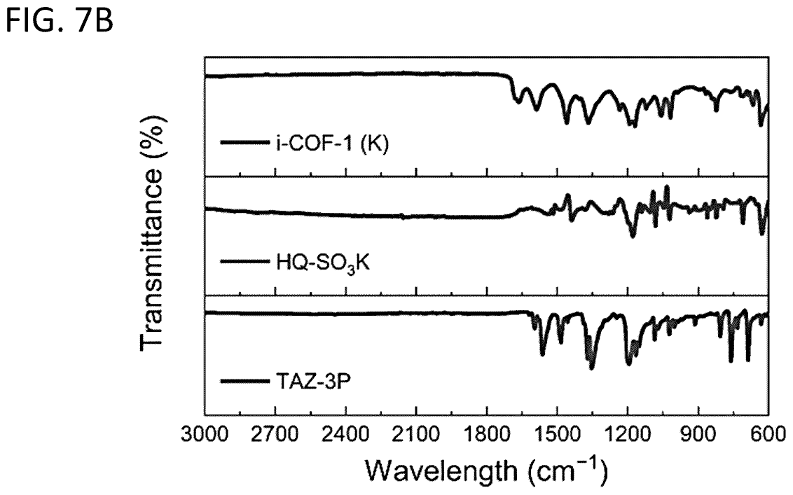

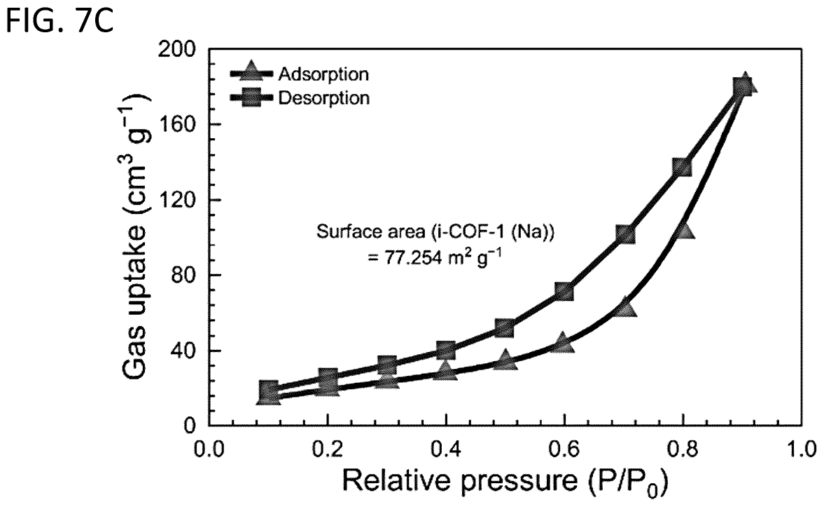

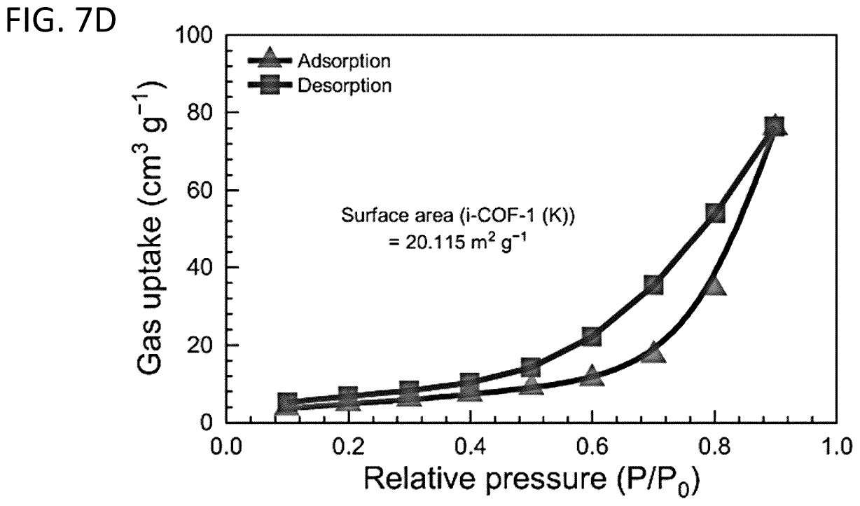

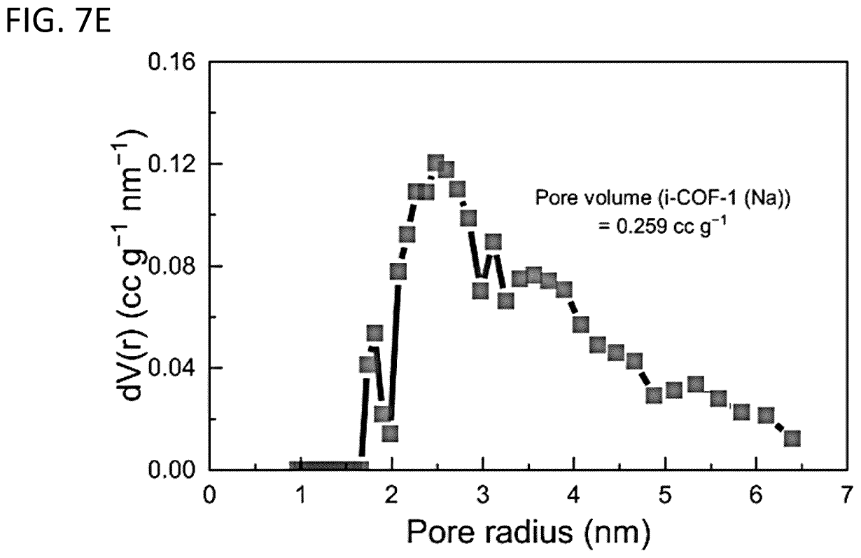

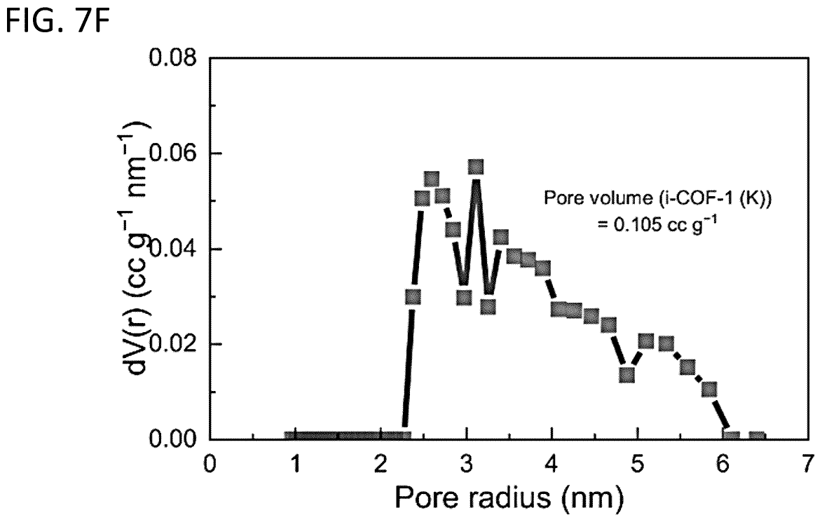

The ionic COF powders prepared were analyzed using Fourier transform infrared (FT-IR) spectroscopy, revealing distinct features in their spectra (FIGS. 7A and 7B). The FT-IR spectrum of i-COF-1 (K) displayed characteristic peaks at 1564 cm⁻¹ and 1355 cm⁻¹ mirroring those found in TAZ-3P, which confirmed the presence of a triazine core. Notably, a peak at 912 cm⁻¹ observed in TAZ-3P was absent in i-COF-1 (K), suggesting that the phenoxy groups from TAZ-3P were largely replaced with the HQ-SO₃K monomer. Additionally, the emergence of a peak at 1058 cm⁻¹ in i-COF-1 (K) and HQ-SO₃K corresponded to the —SO₃K group, indicating successful integration of the potassium sulfonate group within the COF structure. (Fernando, I. R. et al., New J. Chem. 2010, 34 (2), 221-235.) Similar alterations in IR transmittance were also observed for i-COF-1 (Na), indicating a parallel integration process of the sodium sulfonate group.

The surface area and pore size distribution of i-COF-1 (Na) and i-COF-1 (K) were determined through Nitrogen gas adsorption analysis at 77 K (FIGS. 7C-7F). The analysis revealed surface areas of 77.254 m² g⁻¹ for i-COF-1 (Na) and 20.115 m² g⁻¹ for i-COF-1 (K) (FIGS. 7C and 7D). Additionally, the pore volumes were measured at 0.259 cc g⁻¹ for i-COF-1 (Na) and 0.105 cc g⁻¹ for i-COF-1 (K). These values are considerably lower than those typically observed for COFs, likely due to the relatively small pore sizes within the i-COF-1 framework and the presence of a substantial amount of sulfonate and counter alkali ions (i.e., Na⁺ and K⁺).

PXRD analysis suggested that i-COF-1 exhibits an amorphous structure, which may further limit the accessibility of the pores within the framework. Thermogravimetric analysis (TGA) demonstrated the thermal stability of i-COF-1 (Na) and i-COF-1 (K), with no structural decomposition observed up to 400° C. Furthermore, at 700° C., i-COF-1 (Na) and i-COF-1 (K) retained over 60 wt % and 70 wt % of their original mass, respectively. This remarkable thermal stability underscores the usefulness of both i-COF-1 (Na) and i-COF-1 (K) for applications under extreme conditions, including high temperatures.

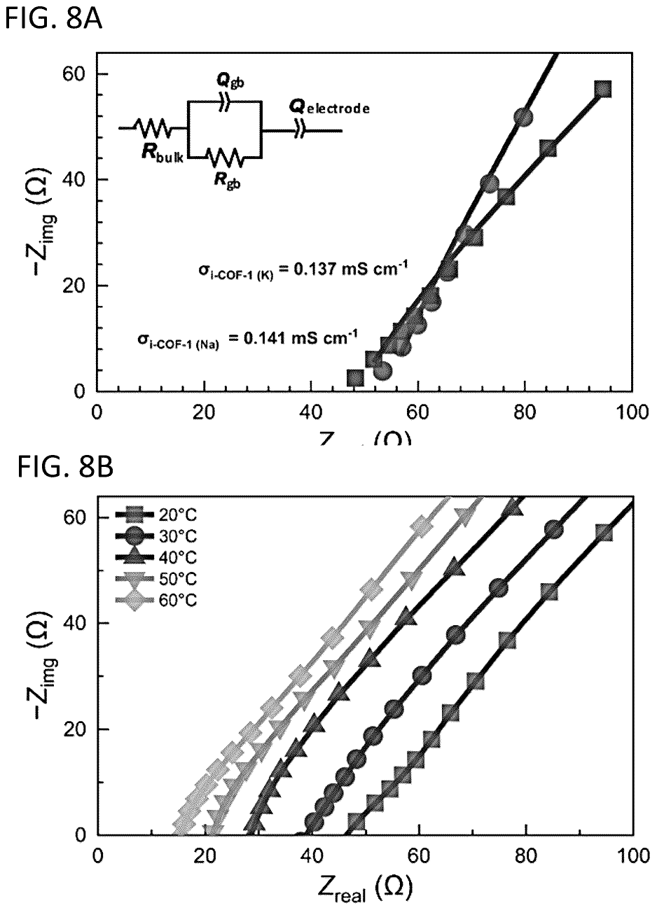

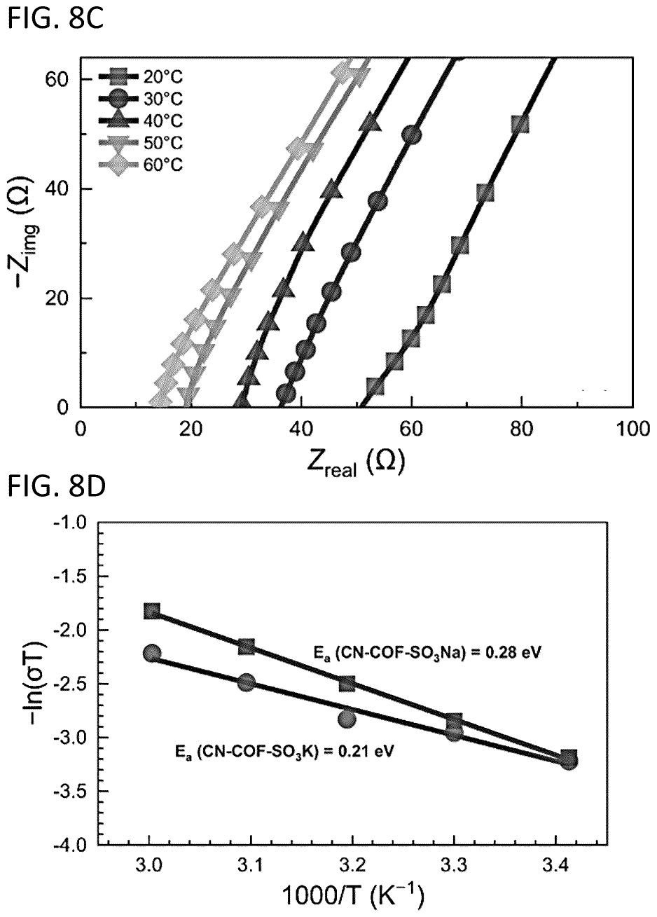

The ionic conducting properties of i-COF-1 (Na) and i-COF-1 (K) were evaluated through electrochemical measurements (FIGS. 8A-8D). Initially, the ionic conductivity at room temperature (20° C.) was determined using electrochemical impedance spectroscopy (EIS) (FIG. 8A). For assessing the ionic conductivity of the COF materials, the COF powders were placed between stainless steel electrodes in a split cell configuration, acting as a blocking cell. These were then compressed under a pressure of 10 MPa for 1 hour to form a uniform COF pellet.

The EIS analysis incorporated an equivalent circuit model to interpret the impedance data, as illustrated in the inset of FIG. 8A. This model included components for the bulk resistance (R_{bulk}) and the grain boundary resistance (R_{gb}), with the total resistance (Rₜₒₜₐₗ) being the sum of these two resistances. (Zhu, L. et al., Sci. Adv. 2022, 8 (11), eabj7698.) The fitting of the EIS data utilized an equivalent circuit composed of R_{bulk}, R_{gb}, along with constant phase elements Q_{gb} and Q_{electrode}, where “R” denotes resistance and “Q” represents a constant phase element indicative of non-ideal capacitive behavior. The bulk and grain boundary resistances were inferred from the x-intercept and the diameter of the semicircle in the low-frequency region of the impedance plot, respectively. Consequently, the total resistance (Rₜₒₜₐₗ) was calculated as the sum of R_{bulk} and R_{gb}. The ionic conductivities of i-COF-1 (Na) and i-COF-1 (K) at room temperature were determined to be 1.41×10⁻⁴ and 1.37×10⁻⁴ S cm⁻¹, respectively. These values, indicative of high ionic conductivity, underscore the unique and superior ionic mechanism facilitated by the ionic COF structure, which achieved significant conductivity despite the generally slow diffusivity of Na- or K-ions. These conductivity figures are comparable to, or exceed, those reported for other COFs or metal-organic frameworks (MOFs), highlighting the potential of i-COF-1 materials in ionic conduction applications (Table 1). (Zhao, G. et al., Nano Energy 2022, 92, 106756; Yan, Y. et al., Nat. Commun. 2023, 14 (1), 3066; Zettl, R. et al., Adv. Energy Mater. 2021, 11 (16), 2003542; Gu, Y. J. et al., ACS Appl. Energy Mater. 2022, 5 (7), 8573-8580; Hayashi, A. et al., Nat. Commun. 2012, 3 (1), 856; Li, X. et al., Matter 2020, 3 (5), 1507-1540; Guin, M. et al., Solid State Ion. 2016, 293, 18-26; Sun, F. et al., Adv. Funct. Mater. 2021, 31 (31), 2102129; Chong, M. K. et al., Ceram. Int. 2022, 48 (15), 22147-22154; Hayashi, A. et al., J. Power Sources 2014, 258, 420-423; Sun, F. et al., ACS Appl. Mater. Interfaces 2021, 13 (11) 13132-13138; Wenzel, S. et al., ACS Appl. Mater. Interfaces 2016, 8 (41), 28216-28224.) Unlike many other COFs or MOFs that exhibit high ionic conductivity typically through the addition of salts or solvents, it is notable that our i-COF-1 demonstrates exceptional ionic conductivities without the need for such additions. This distinct characteristic underscores the intrinsic ionic conduction capabilities of i-COF-1, facilitated by its unique structural composition.

TABLE 1
Na- or K-ion conductivity comparison of newly
developed ionic COF with other COFs or MOFs.

| Solid | Conducting | Additional | σ_{(RT)} | | |
|---|---|---|---|---|---|
| electrolyte | ion | solvent or salt | S cm⁻¹ | temperature | Reference |
| NaOOC—COF | Na-ion | liquid | 2.68 × 10⁻⁴ | RT | Zhao et al., 2022 |
| | | electrolyte | | | |
| | | (10.0 μL, 1.0M) | | | |
| | | of NaPF₆ | | | |
| | | (in propylene | | | |
| | | carbonate, PC) | | | |
| TPDBD- | Na-ion | 9 wt. % | 1.30 × 10⁻⁴ | RT | Yan et al., 2023 |
| CNa-QSSE | | solvents (PC) | | | |
| | | with 5% FEC | | | |
| MIL-121/Na | Na-ion | 50 wt % of 1M | 1.0 × 10⁻⁴ | RT | Zettl et al., 2021 |
| | | NaClO₄ in PC | | | |
| UIOSNa | Na-ion | | 3.6 × 10⁻⁴ | RT | Gu et al., 2022 |
| PHGE-Na | Na-ion | | 3.48 × 10⁻³ | RT | Hayashi et al., 2012 |
| COF-1-Na | Na-ion | 98% relative | 2.5 × 10⁻² | 313 K | Li et al., 2020 |
| | | humidity | | | |
| MOF-808- | K-ion | 20 μL of | 3.1 × 10⁻⁵ | 303 K | Guin et al., 2016 |
| SO₃K | | anhydrous PC | | | |
| TpPa—SO3Li | Li-ion | | 2.7 × 10⁻⁴ | RT | Sun et al., 2021 |
| PEO-n-UIO | Li-ion | 40% UIO/Li- | 1.3 × 10⁻⁴ | 303 K | Chong et al., 2022 |
| | | IL | | | |
| dCOF- | Li-ion | | 2.79 × 10⁻³ | 373 K | Hayashi et al., 2014 |
| ImTFSI-60 | | | | | |
| CF3—Li-Im- | Li-ion | n-BuLi, 20 | 7.20 × 10⁻³ | RT | Sun et al., 2021 |
| COF | | wt % PC | | | |
| LE@ACOF | Li-ion | Li-ion | 3.70 × 10⁻³ | RT | Wenzel et al., 2016 |
| i-COF-1 (Na) | Na-ion | — | 1.41 × 10⁻⁴ | | This example |
| i-COF-1 (K) | K-ion | — | 1.37 × 10⁻⁴ | | This example |

Further investigation into the ion-hopping activation energy (Eₐ) within i-COF-1 (Na) and i-COF-1 (K) was conducted through electrochemical EIS measurements of COF pellets at varying temperatures (20, 30, 40, 50, and 60° C.) (FIGS. 8B-8D). The results, interpreted using the previously mentioned equivalent circuit model, reveal a progressive increase in ionic conductivity with temperature (Table 2 and Table 3). Specifically, the ionic conductivities of i-COF-1 (Na) ranged from 1.41×10⁻⁴ S cm⁻¹ at 20° C. to 4.84×10⁻⁴ S cm⁻¹ at 60° C. Similarly, i-COF-1 (K) exhibited conductivities from 1.37×10⁻⁴ S cm⁻¹ at 20° C. to 3.74×10⁻⁴ S cm⁻¹ at 60° C. The activation energies calculated for i-COF-1 (Na) and i-COF-1 (K) were 0.28 and 0.21 eV, respectively. These relatively low Eₐ values highlight the efficient ion migration within i-COF-1, facilitated by the directional porous channels and the strategically integrated sulfonate groups.

TABLE 2
EIS fitting results of i-COF-1 (Na).
EIS fitting values (i-COF-1 (Na))

| Temperature | R_{bulk} | R_{gb} | Rₜₒₜₐₗ | Thickness | Ionic conductivity |
|---|---|---|---|---|---|
| [K] | [Ohm] | [Ohm] | [Ohm] | [μm] | [S cm⁻¹] |
| 293 | 48.5 | 61.42 | 109.92 | 310 | 1.41 × 10⁻⁴ |
| 303 | 40.69 | 40.09 | 80.78 | 310 | 1.92 × 10⁻⁴ |
| 313 | 30.3 | 28.89 | 59.19 | 310 | 2.62 × 10⁻⁴ |
| 323 | 22.83 | 20.49 | 43.32 | 310 | 3.58 × 10⁻⁴ |
| 333 | 16.85 | 15.18 | 32.03 | 310 | 4.84 × 10⁻⁴ |

TABLE 3
EIS fitting results of i-COF-1 (K).
EIS fitting values (i-COF-1 (K))

| Temperature | R_{bulk} | R_{gb} | Rₜₒₜₐₗ | Thickness | Ionic conductivity |
|---|---|---|---|---|---|
| [K] | [Ohm] | [Ohm] | [Ohm] | [μm] | [S cm⁻¹] |
| 293 | 53.93 | 51.93 | 105.86 | 291 | 1.37 × 10⁻⁴ |
| 303 | 38.14 | 43.06 | 81.2 | 291 | 1.79 × 10⁻⁴ |
| 313 | 31.33 | 40.54 | 71.87 | 291 | 2.02 × 10⁻⁴ |
| 323 | 20.89 | 30.17 | 51.06 | 291 | 2.85 × 10⁻⁴ |
| 333 | 16 | 22.94 | 38.94 | 291 | 3.74 × 10⁻⁴ |

Scanning electron microscopy coupled with energy dispersive X-ray spectroscopy (SEM/EDS) analyses of i-COF-1 (Na) and i-COF-1 (K) pellets were conducted to examine the morphology of the ionic COFs and ensure the uniform distribution of their constituent elements. The SEM images highlighted the uniform packing of COF powders within the pellets, indicating successful compaction and structural integrity. Furthermore, EDS analysis provided a detailed elemental distribution within the pellets, confirming the presence and uniform distribution of carbon (C), nitrogen (N), oxygen (O), sulfur(S), and sodium (Na) in the i-COF-1 (Na) pellet. Similarly, for the i-COF-1 (K) pellet, elements including C, N, O, S, and potassium (K) were uniformly distributed. These findings underscore that the sulfonate groups, —SO₃Na and —SO₃K, were effectively grafted into the COF structures, and the pellets were uniformly prepared through a pressing method at a relatively low pressure of only 10 MPa. This uniform elemental distribution and the integrity of the COF structure facilitate consistent ionic conductivity and the overall performance of the COFs as solid electrolytes. The successful grafting of sulfonate groups and the demonstrated uniformity in pellet preparation highlight the usefulness of i-COF-1 materials in advanced energy storage applications, offering a reliable and efficient medium for ion transport.

The synthesis of TAZ-3P, a monomer for constructing the ionic COF, employs affordable raw materials such as cyanuric chloride, phenol, and potassium carbonate, which contributes to the low synthesis cost of TAZ-3P. Similarly, HQ-SO₃Na, another monomer used in the synthesis of i-COF-1 (Na), can be produced using inexpensive starting materials, including HQ-SO₃K and sodium tetrafluoroborate (NaBF₄). Consequently, the production costs for i-COF-1 (Na) remain low, utilizing cost-effective precursors such as TAZ-3P, HQ-SO₃Na, and sodium methoxide. The synthesis of i-COF-1 (K) also benefits from the use of low-cost materials, including TAZ-3P, HQ-SO₃K, and potassium carbonate.

Moreover, the relatively low true density of these ionic COFs (1.6 g cm 3 for i-COF-1 (Na) and 1.7 g cm 3 for i-COF-1 (K)) offers further advantages, particularly when combined with low-cost organic electrodes that possess soft properties. This synergy enables even more cost-effective battery systems.

### Synthetic Methods

### Synthesis of TAZ-3P

Cyanuric chloride, phenol, and potassium carbonate were obtained from Sigma-Aldrich and used without further purification. 5.52 g (0.03 mol) of cyanuric chloride, 14.1 g (0.15 mol) of phenol, and 20.7 g (0.15 mol) were added to 120 mL of acetone and the solution was heated to 60° C. for 24 hours. After the reaction, water was added to the solution, and it was sonicated for 10 mins to remove the impurities. After that, the white product was filtered, washed with water and acetone, and vacuum dried. A high overall yield of 90% (9.65 g) was obtained for TAZ-3P.

### Synthesis of i-COF-1 (K) (Route 1)

HQ-SO₃K and potassium carbonate were obtained from VWR International LLC and Thermo Scientific Chemicals, respectively. Cyanuric chloride was obtained from Sigma Aldrich. 2.05 g (9 mmol) of HQ-SO₃K, 1.107 g (6 mmol) of cyanuric chloride and 2.49 g (18 mmol) of potassium carbonate were added to 75 mL of ethanol, and the solution was heated to 60° C. for 24 hours. After the reaction, the brown product was filtered, washed with ethanol and acetone, and vacuum dried.

### Synthesis of i-COF-1 (K) (Route 2)

TAZ-3P was prepared by synthesis and HQ-SO₃K and potassium carbonate were obtained from VWR International LLC and Thermo Scientific Chemicals, respectively. 2.05 g (9 mmol) of HQ-SO₃K, 1.072 g (3 mmol) of TAZ-3P and 2.49 g (18 mmol) of potassium carbonate were added to 80 mL of dimethylformamide (DMF), and the solution was heated to 150° C. for 24 hours. After the reaction, the brown product was filtered, washed with DMF and acetone, and vacuum dried. A high overall yield of 90% (4.295 g) was obtained for i-COF-1 (K).

### Synthesis of i-COF-1 (Na)

TAZ-3P was prepared by synthesis. HQ-SO₃Na was prepared by ion-exchange process of HQ-SO₃K, and sodium methoxide was obtained from Sigma-Aldrich. Firstly, 1.92 g (9 mmol) of HQ-SO₃Na was added to 80 mL of dimethylformamide (DMF) and vacuum filtered to remove the impurities. After that, 1.072 g (3 mmol) of TAZ-3P and 1.0 g (18 mmol) of sodium methoxide were added into the filtrate. The solution was heated to 150° C. for 24 hours. After the reaction, the brown product was filtered, washed with DMF and acetone, and vacuum dried. A high overall yield of 81% (1.742 g) was obtained for i-COF-1 (Na).

### Characterization

PXRD of i-COF-1 (K) Synthesized by Different Routes (Route 1 and Route 2):

To identify whether there was remaining KCl in the i-COF-1 (K) samples synthesized by different routes (Route 1 and Route 2), powder X-ray diffraction (PXRD) patterns of the COF powder samples were obtained using a Bruker D8 Discover X-ray diffractometer. The line focused Cu X-ray tube (Cu K_{α1} radiation, λ=1.5418 Å) was set at 50 kV and 1 mA.

ATR-FTIR of i-COF-1 (Na) and i-COF-1 (K):

To identify the formation of covalent bonds and presence of grafted sulfonate groups, the Attenuated total reflectance-Fourier transform Infrared (ATR-FT-IR) spectra of i-COF-1 (Na) and i-COF-1 (K) powders were obtained using a Thermo Scientific Nicolet iS-10 FT-IR spectrometer equipped with an Attenuated Total Reflection (ATR) element of Smart iTX AR Diamond and an OMNIC 7.3 software. The experiments were run with air as the background and were collected from 600 to 3000 cm⁻¹.

BET of i-COF-1 (Na) and i-COF-1 (K):

Nitrogen sorption isotherms were measured at 77 K with a Quantachrome Autosorb ASiQ automated gas sorption analyzer to identify the surface area and pore size distribution.

PXRD of i-COF-1 (Na) and i-COF-1 (K):

To identify crystalline or amorphous properties, powder X-ray diffraction (PXRD) patterns of i-COF-1 (Na) and i-COF-1 (K) were obtained using a Bruker D8 Discover X-ray diffractometer. The line focused Cu X-ray tube (Cu Kal radiation, 2=1.5418 Å) was set at 50 kV and 1 mA.

TGA of i-COF-1 (Na) and i-COF-1 (K):

Thermogravimetric analysis (TGA) was conducted to identify the thermal stability of ionic COF using TA instruments (Model TGA 550). The analysis was performed using nitrogen gas at a flow rate of 40 mL min-1 and the heating rate of 10° C. min-1.

### Electrochemical Data

### Ionic Conductivity and Activation Energy Measurements:

For ionic conductivity measurements, 100 mg of COF powder was added to a split cell (16 mm in diameter) with two stainless-steel electrodes and subjected to compression with 10 MPa for 30 mins using a pressure zig to make COF powder to the pellet and sufficient contact. Electrochemical impedance spectroscopy (EIS) analysis was performed in the frequency range of 100 mHz to 1 MHz to determine the ionic conductivities at different temperatures (20, 40, and 60° C.). Ionic conductivity values were calculated according to Equation (1).

$$σ = \frac{l}{{R}_{total} \times A} \qquad Equation ( 1 )$$

Here, σ is the ionic conductivity of the sample, l is the thickness of the COF pellet, Rₜₒₜₐₗ is the total resistance, and A is the area of the COF pellet.

Activation energy (Eₐ) can be calculated by the Arrhenius equation (Equation (2)).

$$σ T = {σ}_{0} exp ( - \frac{{E}_{a}}{RT} )$$

Here, σ is the ionic conductivity of the sample, T is the temperature of conductivity measurement, R is the gas constant, and Eₐ is the activation energy. The slope of the Arrhenius plots changed to a lesser extent depending upon the composition of the solid electrolyte and temperature; hence the activation energy is directly proportional to the slope.

### Morphological Analysis

Surface SEM/EDS of i-COF-1 (Na) and i-COF-1 (K):

Surface scanning electron microscopy (SEM) images of i-COF-1 (Na) and i-COF-1 (K) pellets were investigated to identify the morphology by a field-emission scanning electron microscopy (ZEISS GeminiSEM 450, Germany), using an InLens detector operating at an accelerating voltage of 5 kV. To determine the uniform distribution of atoms contained in the i-COF-1 (Na) and i-COF-1 (K), EDS measurements were conducted at 20 kV further.

### Example 2

This Example illustrates the synthesis and ionic conductivity of COFs specifically designed for sodium and potassium ion conduction-sodium sulfonated and potassium sulfonated NH-linked COF, designated as i-COF-2 (Na or K) and i-COF-3 (Na or K), respectively. Both COFs contain the sulfonate groups and mobile ions; therefore, they can act as superior single ion conductors without addition of any salt or solvent. In addition, the simple structural modification of COFs could be investigated by simply tuning the monomer structure, and the ionic conducting properties and structural changes were also evaluated.

### Results and Discussion

FIGS. 9A-9D show the synthetic scheme of newly designed two-dimensional (2D) COFs. There are mainly two types of COFs that were developed for this Example. Firstly, i-COF-2 was synthesized through a process involving flexible C—NH—C linkages (FIGS. 9A and 9B). TAZ-3P and 2,5-diaminobenzene sulfonic acid (para-position monomer) were used as starting materials to form covalent bonds and sodium or potassium carbonate was used as a base for converting the proton to sodium form in the sulfonate groups in the COFs. The reaction proceeded under reflux in an organic solvent for one day. Post-reaction, the mixtures were vacuum-filtered, and the resultant solid COF powders were dried overnight at 60° C. in a vacuum oven. This reaction can lead to the formation of sodium or potassium phenolate as a byproduct that can be soluble in the organic solvent used during synthesis. Therefore, only i-COF-2 (Na) or i-COF-2 (K) crashed out as pure products. The second type of COF is i-COF-3 (FIGS. 9C and 9D). The overall synthesis method is same as that for i-COF-2. The only difference is that i-COF-3 was synthesized by using 1,3-diaminobezene sulfonic acid (ortho-position monomer) instead of 2,5-diaminobezene sulfonic acid (para-position monomer). The different position of reaction sites that form the covalent bonds leads to different COF structures, enabling the investigation of the structural effect on ion conducting properties. The synthesis methods are straightforward and cost-efficient, relying on readily available starting materials. The integration of —SO₃⁻ groups and directional channels within the COF structure enhances the diffusivity of Na-ion or K-ion through a hopping mechanism, ensuring efficient pathways for rapid ion transport.

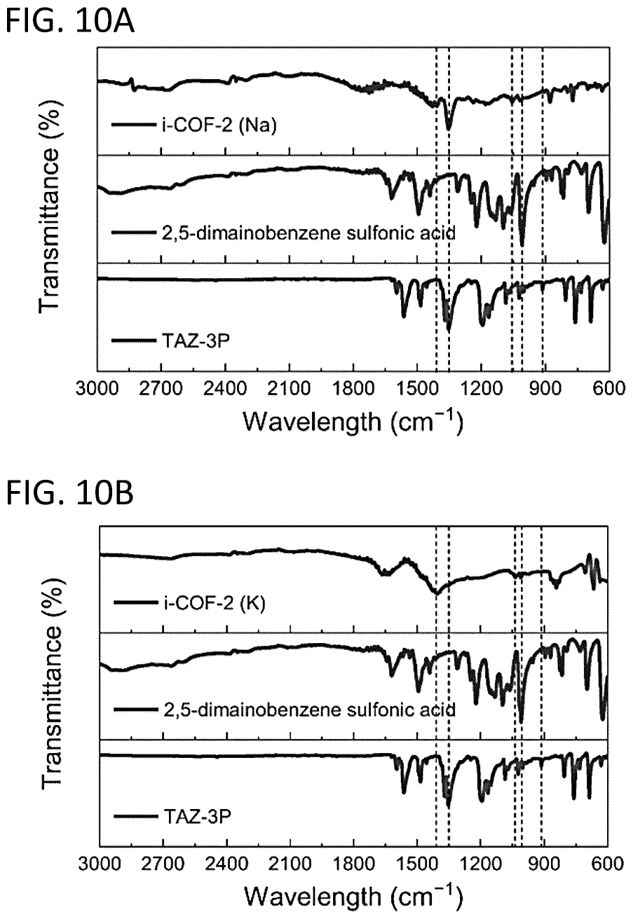

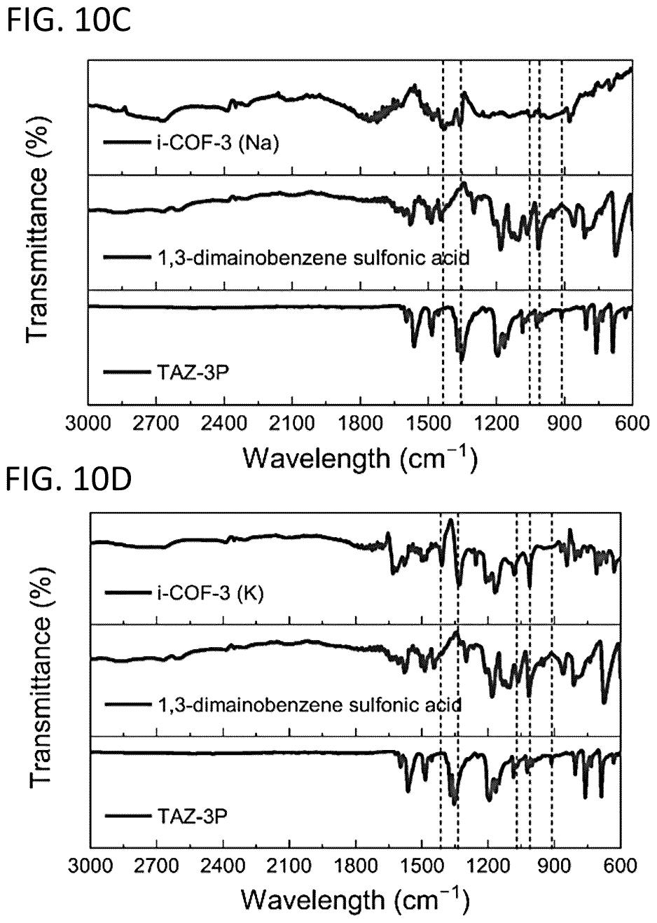

To confirm that covalent bonds were formed and sulfonate groups were integrated in the COF samples, Fourier transform infrared (FT-IR) spectroscopy was used (FIGS. 10A-10D). The FT-IR spectrum of i-COF-2 (Na or K) showed characteristic peaks at 1409 cm⁻¹, indicating the formation of covalent bonds. Furthermore, a peak between 1050 and 1100 cm⁻¹ in the spectra for i-COF-2 (Na or K) and 2,5-diaminobenzene sulfonic acid corresponded to the sulfonate group, indicating successful grafting of sulfonate ionic groups within the COF structures. Additionally, a peak at 1355 cm⁻¹ in the spectra for both i-COF-2 (Na or K) and TAZ-3P confirmed the presence of a triazine core. Notably, a peak at 912 cm⁻¹ observed in the TAZ-3P spectrum was absent in the i-COF-2 (Na or K) spectrum, suggesting that the phenoxy groups from TAZ-3P were largely replaced with the 2,5-diaminobenzene sulfonic acid groups in the COF. Similar alterations in IR transmittance were also observed for i-COF-3 (Na or K), confirming covalent bond formation and the integration of the sodium sulfonate group.

To investigate the amorphous or crystalline structures of synthesized COF powders and whether there is remaining residue, powder X-ray diffraction (PXRD) analysis was performed. There were new peaks which are not relevant to the starting materials and possible byproducts in the PXRD analysis of COF samples, indicating the formation of COFs. The data indicates that the COFs have an amorphous structure.

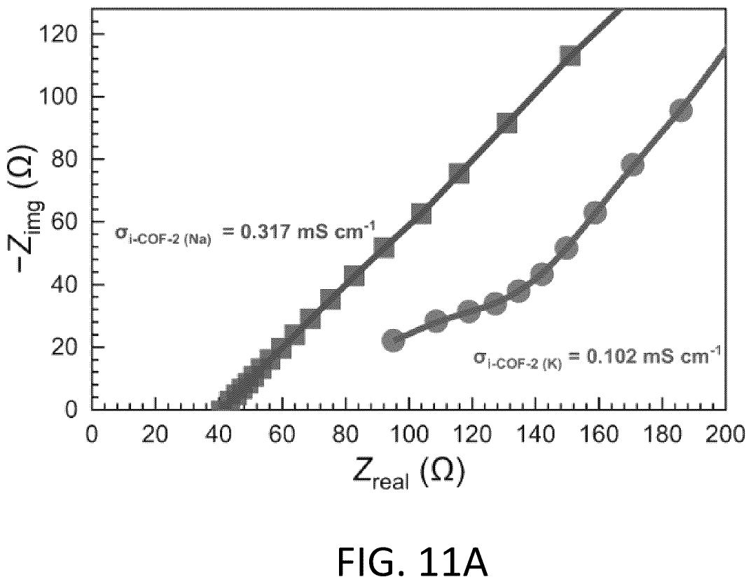

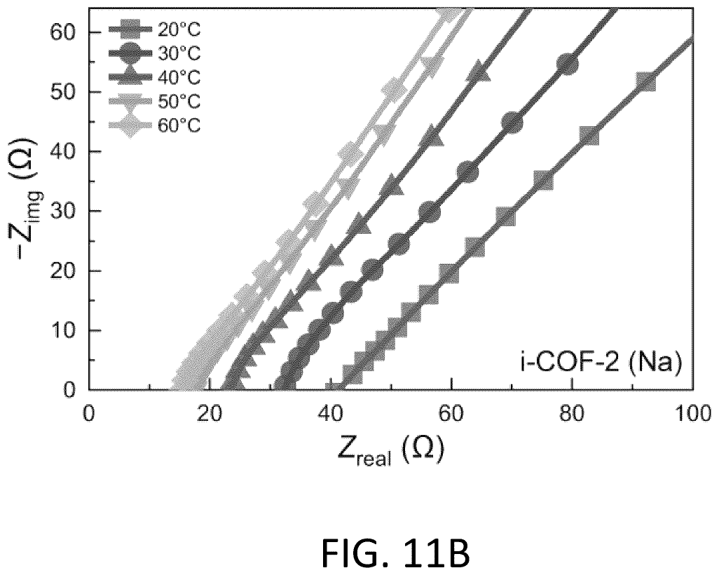

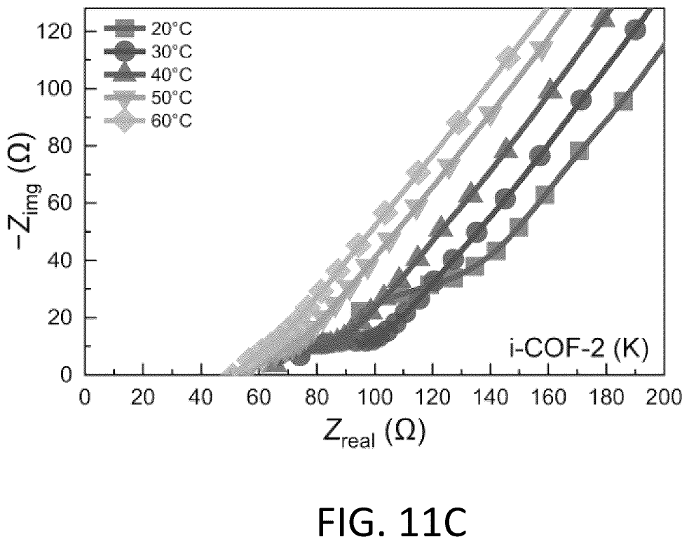

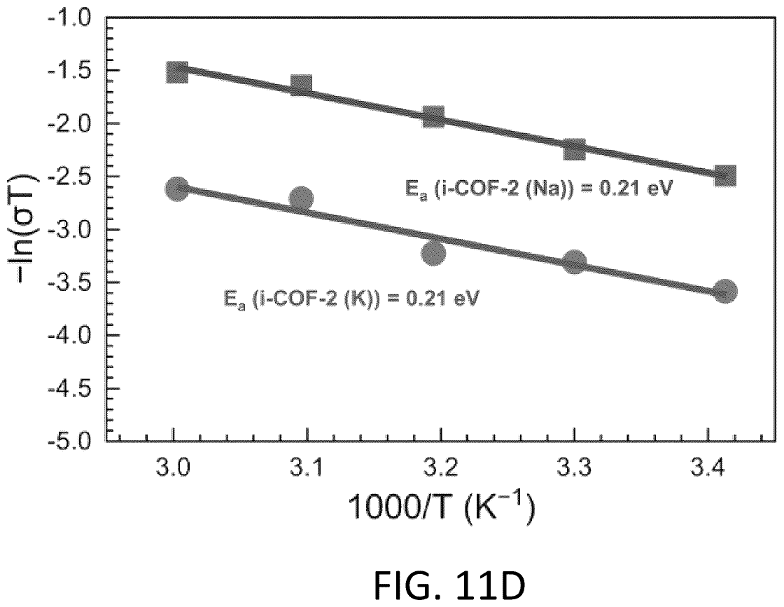

The ionic conducting properties of i-COF-2 (Na) and i-COF-2 (K) were evaluated through electrochemical measurements (FIGS. 11A-11D). Initially, the ionic conductivity at room temperature (20° C.) was determined using electrochemical impedance spectroscopy (EIS) (FIG. 11A). For assessing the ionic conductivity of the COF materials, the COF powders were placed between stainless steel electrodes in a split cell configuration, acting as a blocking cell. These were then compressed under a pressure of 10 MPa for 1 hour to form a uniform COF pellet. The ionic conductivities of i-COF-2 (Na) and i-COF-2 (K) at room temperature were determined to be 3.17×10⁻⁴ and 1.02×10⁻⁴ S cm⁻¹, respectively. The sodium-ion conductivity of i-COF-2 (Na) was higher than potassium-ion conductivity of i-COF-2 (K), indicating the smaller ionic size has faster ion mobility. These values, indicative of high ionic conductivity, underscore the unique and superior ionic mechanism facilitated by the ionic COF structure, which achieves significant conductivity despite the generally slow diffusivity of Na- or K-ions.

Further investigation into the ion-hopping activation energy (Eₐ) within i-COF-2 (Na) and i-COF-2 (K) was conducted through electrochemical EIS measurements of COF pellets at varying temperatures (20, 30, 40, 50, and 60° C.) (FIGS. 3B-3D). The results revealed a progressive increase in ionic conductivity with temperature. Specifically, the ionic conductivities of i-COF-2 (Na) ranged from 3.17×10⁻⁴ S cm⁻¹ at 20° C. to 8.44×10⁻⁴ S cm⁻¹ at 60° C. Similarly, i-COF-2 (K) exhibited conductivities from 1.02×10⁻⁴ S cm⁻¹ at 20° C. to 2.70×10⁻⁴ S cm⁻¹ at 60° C. The activation energies calculated for i-COF-2 (Na) and i-COF-2 (K) were both 0.21 eV. These relatively low Eₐ values highlight the efficient ion migration within i-COF-2, facilitated by the directional porous channels and the strategically integrated sulfonate groups.

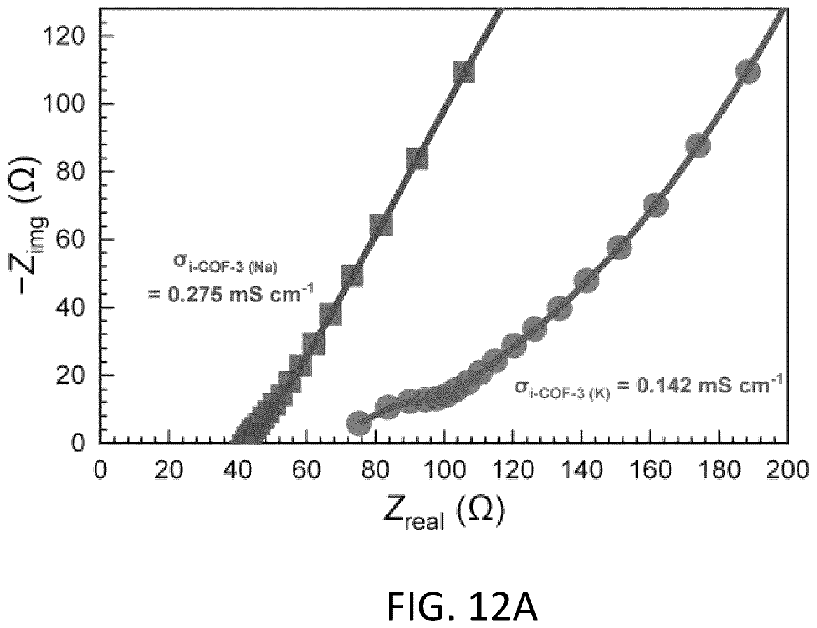

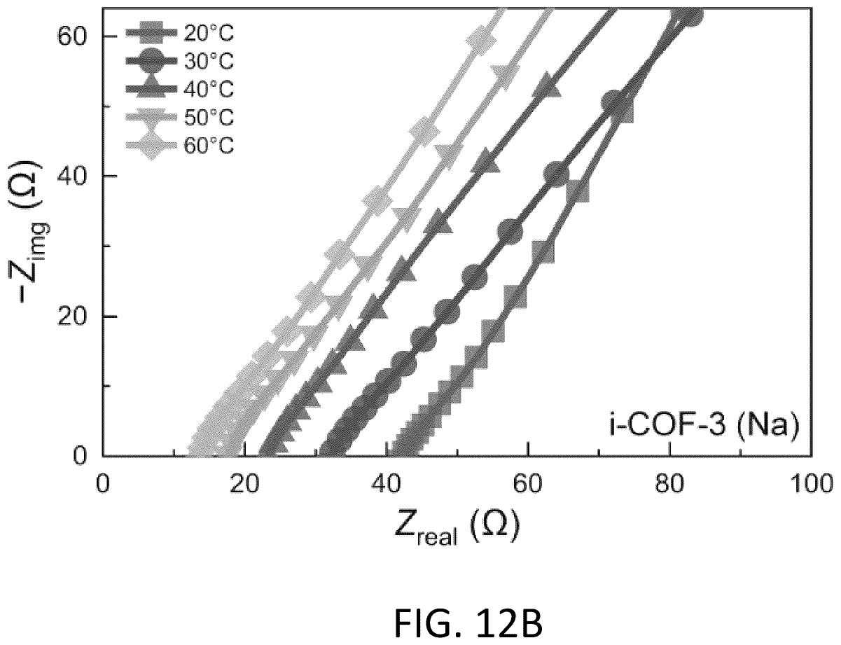

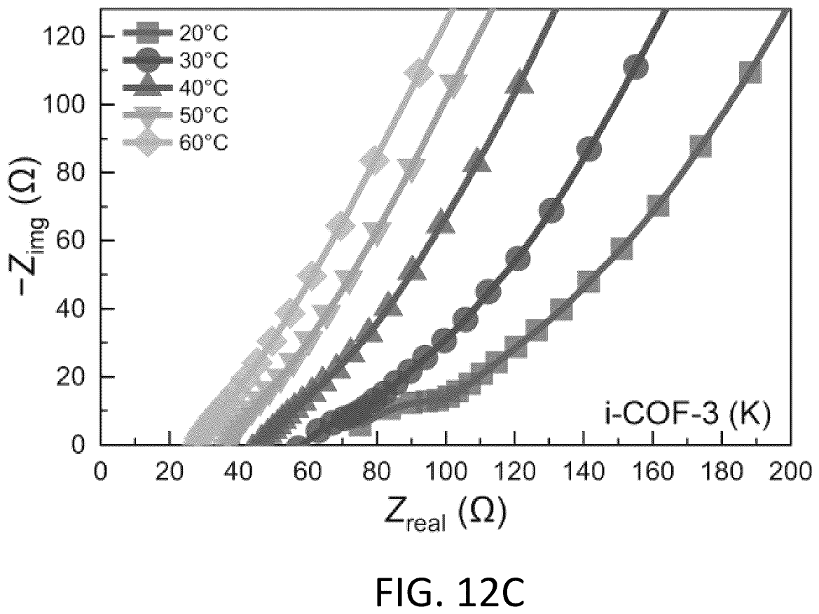

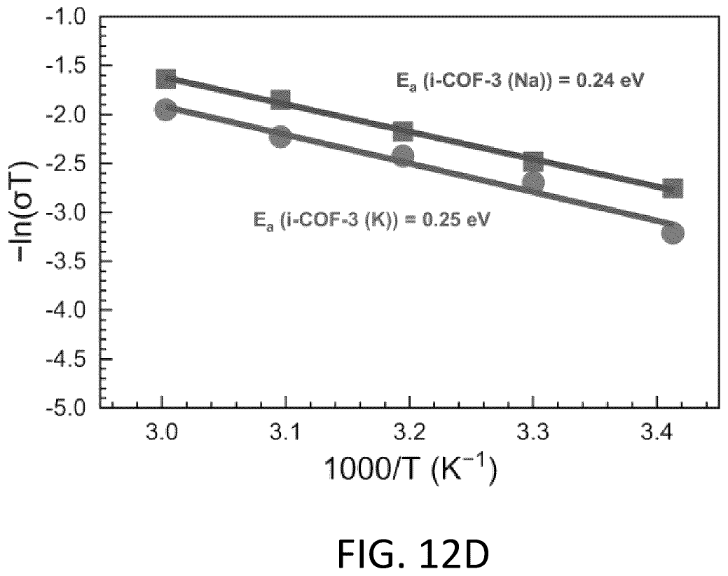

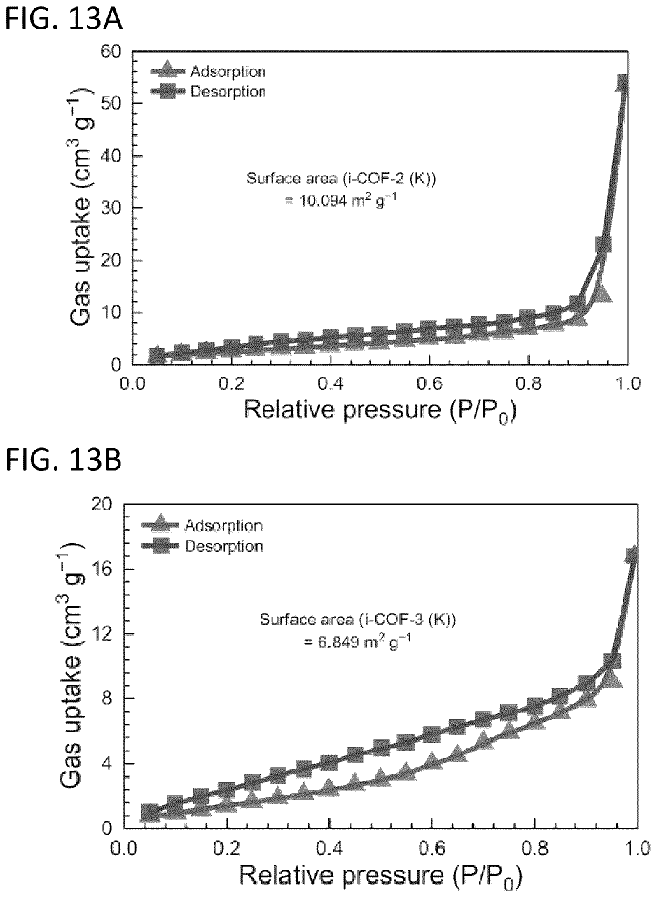

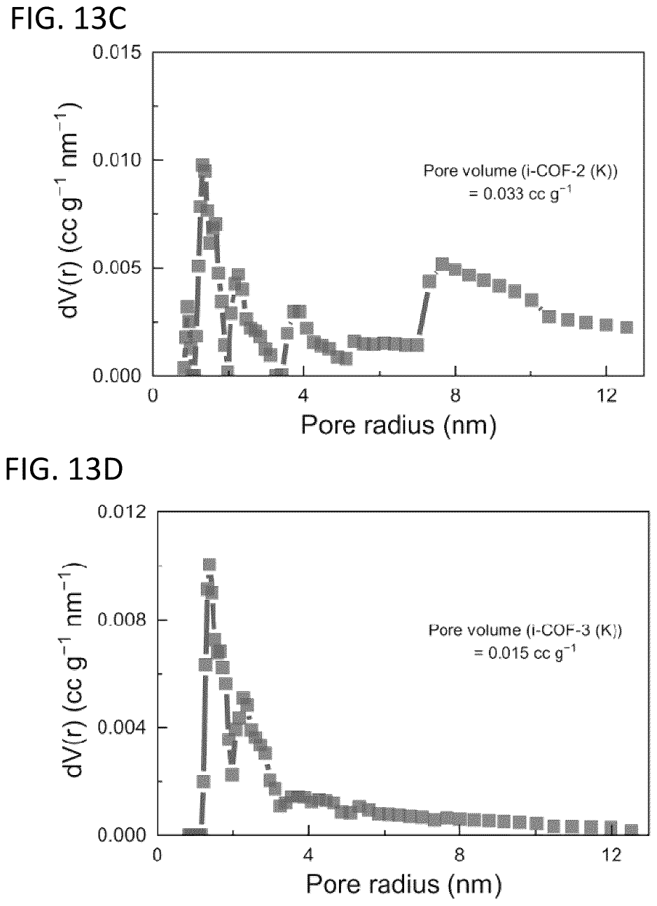

Similarly, the ionic conducting properties of i-COF-3 (Na) and i-COF-3 (K) were also investigated through electrochemical measurements (FIGS. 12A-12D). The ionic conductivities of i-COF-3 (Na) and i-COF-3 (K) at room temperature were determined to be 2.75×10⁻⁴ and 1.42×10⁻⁴ S cm⁻¹, respectively. Further evaluation into the ion-hopping activation energy (Eₐ) within i-COF-3 (Na) and i-COF-3 (K) was conducted through the same method at varying temperatures (20, 30, 40, 50, and 60° C.) (FIGS. 12B-12D). The ionic conductivities of i-COF-3 (Na) increased from 2.75×10⁻⁴ S cm⁻¹ at 20° C. to 8.43×10⁻⁴ S cm⁻¹ at 60° C. with increased temperature. In the same manner, i-COF-3 (K) showed conductivities from 1.42×10⁻⁴ S cm⁻¹ at 20° C. to 5.04×10⁻⁴ S cm⁻¹ at 60° C. The activation energies calculated for i-COF-3 (Na) and i-COF-3 (K) were 0.24 eV and 0.25 eV, respectively, indicating low Eₐ could be achieved by intrinsic properties of ionic COF. Here, the Eₐ of i-COF-3 was higher than that of i-COF-2, meaning that there is the relationship between the structure of COF and ion conducting properties. The structural difference between i-COF-2 and i-COF-3 could be achieved by altering the position of reaction sites of one monomer (diaminobenzene sulfonic acid) used in the synthesis (para-positioned monomer for i-COF-2 and ortho-positioned monomer for i-COF-3). This simple difference changes the COF structures, demonstrating the easy tunability of COFs. The lower Eₐ of i-COF-2 than i-COF-3 is consistent with the larger surface area and pore volume of i-COF-2 (FIGS. 13A-13D). The larger surface area and pore volume can provide more free space for ion transport.

The ion conducting properties of i-COF-2 and i-COF-3 are comparable to, or exceed, those reported for other COFs or metal-organic frameworks (MOFs) (Table 4). Some previously reported COFs or MOFs showed high ionic conductivity and low Eₐ. However, they involved additional solvent or salt for the conductivity measurements. On the other hand, the COFs described herein show good ion conducting properties even without the addition of any solvent or salt. This superior ion conductivity without any solvent or salt can be attributed to the sulfonate groups containing mobile ions already in the COF structure itself. The grafted sulfonate groups can provide more ion hopping sites, and including mobile ions (sodium-ion or potassium-ion) in the ionic groups during the synthesis produces COFs that are single ion conductors.

TABLE 4
Na- or K-ion conductivity comparison of newly
developed ionic COF with other COFs or MOFs.

| Solid | Conducting | Additional | Eₐ | σ_{(RT)} | |
|---|---|---|---|---|---|
| electrolyte | ion | solvent or salt | eV | S cm⁻¹ | Reference |
| NaOOC—COF | Na-ion | liquid | 0.24 | 2.68 × 10⁻⁴ | G. Zhao et al., Nano |
| | | electrolyte | | | Energy, 2022, 92, |
| | | (10.0 μL, 1.0M) | | | 106756. |
| | | of NaPF₆ | | | |
| | | (in propylene | | | |
| | | carbonate, PC) | | | |
| TPDBD- | Na-ion | 9 wt. % | 0.204 | 1.30 × 10⁻⁴ | Y. Yan et al., Nat. |
| CNa-QSSE | | solvents (PC) | | | Commun., 2023, 14, |
| | | with 5% FEC | | | 3066. |
| MIL-121/Na | Na-ion | 50 wt % of 1M | 0.36 | 1.0 × 10⁻⁴ | R. Zettl et al., Adv. |
| | | NaClO₄ in PC | | | Energy Mater., 2021, |
| | | | | | 11, 2003542. |
| MOF-808- | K-ion | 20 μL of | 0.32 | 3.1 × 10⁻⁵ | Y. J. Gu et al., ACS |
| SO₃K | | anhydrous PC | | | Appl. Energy Mater., |
| | | | | | 2022, 5, 8573-8580. |
| i-COF—2(Na) | Na-ion | — | 0.21 | 3.17 × 10⁻⁴ | This Example |
| i-COF—2(K) | K-ion | — | 0.21 | 1.02 × 10⁻⁴ | |
| i-COF—3(Na) | Na-ion | — | 0.24 | 2.75 × 10⁻⁴ | |
| i-COF—3(K) | K-ion | — | 0.25 | 1.42 × 10⁻⁴ | |

Scanning electron microscopy coupled with energy dispersive X-ray spectroscopy (SEM/EDS) analyses of i-COF-2, 3 (Na) and i-COF-2, 3 (K) pellets were conducted to examine the morphology of the ionic COFs and ensure the uniform distribution of their constituent elements. The SEM images highlighted the uniform packing of COF powders within the pellets, indicating successful compaction and structural integrity. Furthermore, EDS analysis provided a detailed elemental distribution within the pellets, confirming the presence and uniform distribution of carbon (C), nitrogen (N), oxygen (O), sulfur(S), and sodium (Na) in the i-COF-2, 3 (Na) pellets. Similarly, for the i-COF-2, 3 (K) pellets, elements including C, N, O, S, and potassium (K) were uniformly distributed. These findings underscore that the sulfonate groups, —SO₃Na and —SO₃K, were effectively grafted into the COF structures, and the pellets were uniformly prepared through a pressing method at a relatively low pressure of only 10 MPa. This uniform elemental distribution and the integrity of the COF structure facilitate consistent ionic conductivity and the overall performance of the COFs as solid electrolytes.

The detailed characterizations and electrochemical assessments provided in this Example confirm that i-COF-2, 3 (Na) and i-COF-2, 3 (K) exhibit superior qualities, enabling high ionic conductivity for the cost-efficient and plentiful sodium and potassium ions. This significant discovery highlights the viability of these novel ionic covalent organic frameworks (COFs) as cost-effective materials, that utilize low-cost precursors.

### Experimental Section

### Synthetic Methods

### Synthesis of TAZ-3P

Cyanuric chloride, phenol, and potassium carbonate were obtained from Sigma-Aldrich, and used without further purification. 5.52 g (0.03 mol) of cyanuric chloride, 14.1 g (0.15 mol) of phenol, and 20.7 g (0.15 mol) were added to 120 mL of acetone and the solution was heated to 60° C. for 24 hours. After the reaction, water was added to the solution, and it was sonicated for 10 mins to remove the impurities. After that, the white product was filtered, washed with water and acetone, and vacuum dried. A high overall yield of 90% (9.65 g) was obtained for TAZ-3P.

### Synthesis of i-COF-2 (Na)

TAZ-3P was prepared by synthesis and 2,5-diaminobenzenesulfonic acid and sodium carbonate were obtained from Sigma-Aldrich and Thermo Scientific Chemicals, respectively. 3.38 g (18 mmol) of 2,5-diaminobenzenesulfonic acid, 4.288 g (12 mmol) of TAZ-3P and 3.82 g (36 mmol) of sodium carbonate were added to 80 mL of dimethylformamide (DMF), and the solution was heated to 150° C. for 24 hours. After the reaction, the light red-brown product was filtered, washed with DMF and acetone, and vacuum dried.

### Synthesis of i-COF-2 (K)

TAZ-3P was prepared by synthesis and 2,5-diaminobenzenesulfonic acid and potassium carbonate were obtained from Sigma-Aldrich and Thermo Scientific Chemicals, respectively. 3.38 g (18 mmol) of 2,5-diaminobenzenesulfonic acid, 4.288 g (12 mmol) of TAZ-3P and 4.98 g (36 mmol) of potassium carbonate were added to 80 mL of dimethylformamide (DMF), and the solution was heated to 150° C. for 24 hours. After the reaction, the light red-brown product was filtered, washed with DMF and acetone, and vacuum dried.

### Synthesis of i-COF-3 (Na)

TAZ-3P was prepared by synthesis and 1,3-diaminobenzenesulfonic acid and sodium carbonate were obtained from TCI America and Thermo Scientific Chemicals, respectively. 3.38 g (18 mmol) of 1,3-diaminobenzenesulfonic acid, 4.288 g (12 mmol) of TAZ-3P and 3.82 g (36 mmol) of sodium carbonate were added to 80 mL of dimethylformamide (DMF), and the solution was heated to 150° C. for 24 hours. After the reaction, the off-white product was filtered, washed with DMF and acetone, and vacuum dried.

### Synthesis of i-COF-3 (K)

TAZ-3P was prepared by synthesis and 1,3-diaminobenzenesulfonic acid and potassium carbonate were obtained from TCI America and Thermo Scientific Chemicals, respectively. 3.38 g (18 mmol) of 1,3-diaminobenzenesulfonic acid, 4.288 g (12 mmol) of TAZ-3P and 4.98 g (36 mmol) of potassium carbonate were added to 80 mL of dimethylformamide (DMF), and the solution was heated to 150° C. for 24 hours. After the reaction, the off-white product was filtered, washed with DMF and acetone, and vacuum dried.

### Characterization

### PXRD of COFs:

To confirm COF formation and determine whether there were remaining residues related to monomers in the COF samples, powder X-ray diffraction (PXRD) patterns of the COF powder samples and starting materials were obtained using a Bruker D8 Discover X-ray diffractometer. The line focused Cu X-ray tube (Cu K_{α1} radiation, λ=1.5418 Å) was set at 50 kV and 1 mA.

ATR-FTIR of i-COF-2 (Na or K) and i-COF-3 (Na or K):

To identify the formation of covalent bonds and presence of grafted sulfonate groups, the Attenuated total reflectance-Fourier transform Infrared (ATR-FT-IR) spectra of i-COF-2 (Na or K) and i-COF-3 (Na or K) powders were obtained using a Thermo Scientific Nicolet iS-10 FT-IR spectrometer equipped with an Attenuated Total Reflection (ATR) element of Smart iTX AR Diamond and an OMNIC 7.3 software. The experiments were run with air as the background and were collected from 600 to 3000 cm⁻¹.

BET of i-COF-2 (K) and i-COF-3 (K):

Nitrogen sorption isotherms were measured at 77 K with a Quantachrome Autosorb ASiQ automated gas sorption analyzer to identify the surface area and pore size distribution.

Electrochemical Data was collected using the process described in Example 1.

### Morphological Analysis

Surface SEM/EDS of i-COF-2 (Na or K) and i-COF-3 (Na or K) Pellets:

Surface scanning electron microscopy (SEM) images of i-COF-2 (Na or K) and i-COF-3 (Na or K) pellets were investigated to identify the morphology by a field-emission scanning electron microscopy (ZEISS GeminiSEM 450, Germany), using an InLens detector operating at an accelerating voltage of 3 kV. To determine the uniform distribution of atoms contained in the i-COF-1 (Na) and i-COF-1 (K), further EDS measurements were conducted at 20 kV.

### Example 3

This Example illustrates the synthesis and ionic conductivity of a COFs designed for zinc ion conduction. The structure of the COF is that of i-COF-3, but having Zn²⁺ charge-balancing cations, rather than Na⁺ or K⁺ cations. The COF contains sulfonate groups and mobile zinc cations and, therefore, can act as a single ion conductors without addition of any salt or solvent.

The COF (i-COF-3 (Zn)) was synthesized using the methods described in Example 3 with zinc carbonate as the metal salt, DMF as a polar organic solvent, a reaction temperature of 130° C., and a reaction time of 1 day. The ionic conductivity, based on EIS, of the COF was 2.87.S/cm.

Unless otherwise indicated, all measurable quantitative values disclosed herein that are temperature and/or pressure dependent refer to those values as measured at room temperature (23° C.) and standard atmospheric pressure (atm).

The word “illustrative” is used herein to mean serving as an example, instance, or illustration. Any aspect or design described herein as “illustrative” is not necessarily to be construed as preferred or advantageous over other aspects or designs. Further, for the purposes of this disclosure and unless otherwise specified, “a” or “an” means “one or more.”

The foregoing description of illustrative embodiments of the invention has been presented for purposes of illustration and of description. It is not intended to be exhaustive or to limit the invention to the precise form disclosed, and modifications and variations are possible in light of the above teachings or may be acquired from practice of the invention. The embodiments were chosen and described to explain the principles of the invention and as practical applications of the invention to enable one skilled in the art to utilize the invention in various embodiments and with various modifications as suited to the particular use contemplated. It is intended that the scope of the invention be defined by the claims appended hereto and their equivalents.

What is claimed is:

1. A covalent organic framework comprising: a crosslinked core comprising triazine groups covalently crosslinked to phenyl groups; anionic substituents grafted to phenyl rings of the phenyl groups; and metal cations associated with the anionic substituents via electrostatic interactions, wherein crosslinked core does not include imine crosslinks.

2. The covalent organic framework of claim 1, wherein the phenyl groups are crosslinked to the triazine groups by a crosslink comprising an amine bond.

3. The covalent organic framework of claim 1, wherein the phenyl groups are crosslinked to the triazine groups by a crosslink comprising an ether bond.

4. The covalent organic framework of claim 1, wherein the phenyl groups are crosslinked to the triazine groups by crosslinks at the para-position and the meta-positions, with respect to the anionic substituent, of the phenyl rings.

5. The covalent organic framework of claim 1, wherein the phenyl groups are crosslinked to the triazine groups by crosslinks at the para-position and the ortho-positions, with respect to the anionic substituent, of the phenyl rings.

6. The covalent organic framework of claim 1, wherein the anionic substituents comprise a sulfonate group.

7. The covalent organic framework of claim 1, wherein the anionic substituents comprise a carboxylate group.

8. The covalent organic framework of claim 1, wherein the metal cations comprise alkali metal cations.

9. The covalent organic framework of claim 8, wherein the alkali metal cations comprise sodium cations or potassium cations.

10. The covalent organic framework of claim 2, wherein the anionic substituents are sulfonate groups and the metal cations are sodium cations or potassium cations.

11. The covalent organic framework of claim 3, wherein the anionic substituents are sulfonate groups and the metal cations are sodium cations or potassium cations.

12. The covalent organic framework of claim 1, wherein the metal cations comprise alkaline metal cations or transition metal cations.

13. An electrochemical cell comprising:
a cathode;
an anode in electrical communication with the cathode; and
a metal ion-permeable solid electrolyte disposed between the cathode and the anode, the solid electrolyte comprising covalent organic framework comprising: a crosslinked core comprising triazine groups covalently crosslinked to phenyl groups; anionic substituents grafted to phenyl rings of the phenyl groups; and metal cations associated with the anionic substituents via electrostatic interactions.

14. The electrochemical cell of claim 13, wherein the metal cations are sodium ions or potassium ions.

15. The electrochemical cell of claim 13, wherein metal ion-permeable solid electrolyte does not contain a liquid comprising free ions.

16. A method of making a covalent organic framework, the method comprising reacting: (a) 2,4,6-triphenoxy-1,3,5-triazine or cyanuric chloride with; (b) a phenylene diamine bearing an anionic ring substituent or a phenylene diol bearing an anionic ring substituent in the presence of a metal salt base to form the covalent organic framework comprising: a crosslinked core comprising triazine groups covalently crosslinked to phenyl groups; anionic substituents grafted to phenyl rings of the phenyl groups; and metal cations associated with the anionic substituents via electrostatic interactions.

17. The method of claim 16, wherein the metal salt base is a metal carbonate.

18. The method of claim 17, wherein the 2,4,6-triphenoxy-1,3,5-triazine is reacted with the phenylene diamine bearing an anionic ring substituent and said phenylene diamine bearing an anionic ring substituent is 2,5-diaminobenzene sulfonic acid or 2,5-diaminoebenzoic acid.

19. The method of claim 17, wherein the 2,4,6-triphenoxy-1,3,5-triazine is reacted with the phenylene diol bearing an anionic ring substituent and said phenylene diol bearing an anionic ring substituent is hydroquinone monosulfonic acid or 2,5-dihydroxybenzoic acid.
